(19) United States
(12) Patent Application Publication
(10) Pub. No.: US 2009/0002378 A1
(43) Pub. Date: Jan. 1, 2009

(54) Pipeline Architecture for Video Encoder and Decoder

(75) Inventor: Takahiro Kondo, Fukuoka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 10/578,012

(22) PCT Filed: Sep. 30, 2005
(86) PCT No.: PCT/JP2005/018596

§ 371 Date: Sep. 17, 2008

(30) Foreign Application Priority Data
Oct. 13, 2004 (JP) 2004-298841

(51) Int. Cl. G06T 1/20; G06F 11/08

(52) U.S. Cl. 345/506; 714/799; 714/E11.03

(57) ABSTRACT

An image data-processing apparatus (100) includes an image data-decoding unit (10) operable to execute pipeline processing-assisted image decoding processing, a pipeline controller (20) operable to control pipeline processing in the image data-decoding unit (10), a memory (30), and an input/output interface (40). The pipeline controller (20) executes control over the pipeline processing on the basis of information on the start-up of pipeline stages. The information is stored in a start-up table storage unit (23). The present configuration makes it feasible to provide an image data-processing apparatus operable to suppress degradation in decoded images to a minimum degree when pipeline control is disturbed upon the occurrence of decoding errors during the decoding processing, whereby high-quality images are realized.

### TECHNICAL FIELD

The present invention relates to an image data-processing apparatus and, more particularly, to an image data-processing apparatus and method operable to practice the high-speed and efficient encoding and decoding of image data through pipeline processing.

### BACKGROUND ART

The encoding and decoding of image data represented by the MPEG (Moving Picture Experts Group) standard includes a series of encoding and decoding processes. For example, a MPEG system decoding process includes variable length decoding processing, inverse quantization processing, inverse DCT (Inverse Discrete Cosine Transformation) processing, and motion compensation processing, while a MPEG system encoding process includes variable length encoding processing, DCT processing, quantization processing, motion detection processing, motion compensation processing, inverse quantization processing, and inverse DCT processing.

A prior art operable to practice the high-speed encoding and decoding of image data through such a chain of processes is incorporated into an image data-processing apparatus as disclosed by cited patent reference No. 1.

FIG. 17 is a block diagram illustrating a prior art image data-processing apparatus 1 as disclosed by the cited reference No. 1 (published Japanese Patent Application Laid-Open No. (HEI) 7-240844). The image data-processing apparatus 1 of FIG. 17 includes a plurality of independent processing units (such as a pixel processing unit 2 responsible for the DCT and quantization processing, a motion-predicting unit 3 for motion prediction processing, and a variable length processor 6 for variable length encoding), and an overall control processor 5 operable to control the above processing units to operate them in parallel as pipeline stages. More specifically, the image data-processing unit 1 executes pipeline control over the plurality of independently operated processing units, thereby realizing the high-speed encoding and decoding of image data.

However, the prior art image data-processing apparatuses designed for the encoding and decoding as just discussed are inapplicable to apparatuses for use in circumstances in which data errors may often occur in encoded data under transmittance, as encountered in cellular phones that frequently use wireless circumstances as transmission channels. This is because, when the data errors occur during the data transmission, the prior art image data-processing apparatuses are impossible to meet requirements in which data error-causing degradation in decoded images is suppressed to a minimum extent to maintain high-quality images.

More specifically, the prior art image data-processing apparatuses are not constructed to cope with situations in which control over pipeline processing is disturbed when decoding errors occur because of the data errors in the encoded data under decoding process, or otherwise when the decoding process resumes after the occurrence of the decoding errors. As a result, when the decoding errors occur during the decoding process, the prior art image data-processing apparatuses only can discard all pieces of data under the pipeline processing to conceal the errors using an immediately previous decoded image. Consequently, the decoded images are considerably degraded.

### DISCLOSURE OF THE INVENTION

In view of the above, an object of the present invention is to provide an image data-processing apparatus and method operable to practice the pipeline processing-assisted, high-speed encoding and decoding of image data, and to avoid pipeline control disturbances caused by the occurrence of decoding errors during decoding process, thereby suppressing degradation in decoded images to a minimum extent, with the result that high-quality images are provided.

A first aspect of the present invention provides an image data-processing apparatus including: an image data-decoding unit operable to allow input encoded data fed into the image data-processing apparatus to be decoded through pipeline processing, thereby providing decoded image data; a pipeline controller operable to control the pipeline processing in the image data-decoding unit; and a memory operable to store the input encoded data and the decoded image data.

According to the above configuration, an image data-processing apparatus dedicated to decoding encoded data and operable to run at high speed through the pipeline processing is provided.

A second aspect of the present invention provides an image data-processing apparatus in which the image data-decoding unit includes a several staged data-processing unit operable to practice the pipeline processing. In the image data-processing apparatus, the several staged data-processing unit includes at least two of: a variable length decoding processing unit operable to practice the variable length decoding of the input encoded data, thereby providing quantized DCT coefficients and a motion vector; an inverse quantization processing unit operable to inversely quantize the quantized DCT coefficients from the variable length decoding processing unit, thereby providing inversely quantized DCT coefficients; an inverse DCT processing unit operable to practice the inverse DCT processing of the inversely quantized DCT coefficients from the inverse quantization processing unit, thereby providing DCT coefficients; and a motion compensation processing unit operable to generate decoded image data of the present frame using the DCT coefficients from the inverse DCT processing unit, the motion vector from the variable length decoding processing unit, and decoded image data of a previous frame stored in the memory.

According to the above configuration, an image data-processing apparatus operable to decode MPEG standard encoded data at high speed through the pipeline processing is achievable.

A third aspect of the present invention provides an image data-processing apparatus in which the pipeline controller includes: a start-up table storage unit operable to contain a pipeline start-up table in which start-up information on control over the pipeline processing in the image data-decoding unit is registered; an offset-determining unit operable to determine an offset value for use in referencing the pipeline start-up table in the start-up table storage unit; a start-up stage-determining unit operable to read the start-up information from the pipeline start-up table in the start-up table storage unit in accordance with the offset value determined by the offset-determining unit, thereby determining a start-up method for the pipeline processing in the image data-decoding unit; and a pipeline control unit operable to control the offset-determining unit and the start-up stage-determining unit, thereby controlling the pipeline processing in the image data-decoding unit in accordance with the start-up method for the pipeline processing as determined by the start-up stage-determining unit.

According to the above configuration, when the pipeline processing in the image data-decoding unit is disturbed by the occurrence of decoding errors during decoding process, then the pipeline start-up table is referenced based on the offset value, thereby immediately brining the disturbed pipeline processing into normal operation. As a result, degradation in image quality is suppressible to a minimum extent, which otherwise would be conspicuous because of the decoding errors in decoded images.

A fourth aspect of the present invention provides an image data-processing apparatus, further including an error concealment processing unit. In the image data-processing apparatus, the variable length decoding processing unit further includes a code error-detecting unit operable to detect a code error from the input encoded data. In the image data-processing apparatus, when the code error-detecting unit detects the code error from the input encoded data at a macro block thereof, then the error concealment processing unit applies previously decoded image data from the memory onto the macro block at which the error has been detected, and onto subsequent macro blocks, thereby concealing a disturbance in decoded image display. The disturbance is caused by the code error in the input encoded data.

A fifth aspect of the present invention provides an image data-processing apparatus in which, when the code error-detecting unit detects a code error at a macro block of the input encoded data, then the error concealment processing unit excludes previously processed macro blocks from targets at which the disturbance in decoded image display is to be concealed. The previously processed macro blocks are processed earlier, by the number of stages of the pipeline processing, than the macro block at which the error has been detected.

Each of the above two different configurations eliminates the need to discard all data under decoding process when the pipeline processing in the image data-decoding unit is disturbed by the occurrence of decoding errors during the decoding process. Instead, decoded image data at fully decoded macro blocks are directly used, while previously decoded image data stored in the memory is applied onto the other macro blocks that still remain to be decoded because of the occurrence of the decoding errors, with the result that disturbances in the display of decoded images can be concealed. More specifically, the decoding errors can be concealed for each of the macro blocks, and decoding error-caused degradation in image quality of the decoded images is suppressible to a minimum extent.

A sixth aspect of the present invention provides an image data-processing apparatus including: an image data-encoding unit operable to allow input image data fed into the image data-processing apparatus to be encoded through pipeline processing, thereby providing encoded data; a pipeline controller operable to control the pipeline processing in the image data-encoding unit; and a memory operable to store reconfigured image data corresponding to the input image data, and the encoded data.

According to the above configuration, an image data-processing apparatus dedicated to encode image data and operable to run at high speed in accordance with the pipeline processing is provided.

A seventh aspect of the present invention provides an image data-processing apparatus in which the image data-encoding unit includes a several staged data-processing unit operable to execute the pipeline processing. The several staged data-processing unit includes at least two of: a motion detection processing unit operable to detect a motion vector of the present frame, using the input image data, which is input image data of the present frame, and reconfigured image data of a previous frame stored in the memory; a motion compensation processing unit operable to generate predicted image data of the present frame, using the motion vector detected by the motion detection processing unit, and the reconfigured image data of the previous frame in the memory; a DCT processing unit operable to practice the DCT processing of a difference between the predicted image data generated by the motion compensation processing unit, and the input image data, thereby providing DCT coefficients; a quantization processing unit operable to quantize the DCT coefficients from the DCT processing unit, thereby providing quantized DCT coefficients; an inverse quantization processing unit operable to inversely quantize the quantized DCT coefficients from the quantization processing unit, thereby providing inversely quantized DCT coefficients; an inverse DCT processing unit operable to practice the inverse DCT processing of the inversely quantized DCT coefficients from the inverse quantization processing unit, thereby providing DCT coefficients for use in obtaining reconfigured image data; and a variable length encoding processing unit operable to practice the variable length encoding of the quantized DCT coefficients from the quantization processing unit and the motion vector detected by the motion detection processing unit, thereby providing encoded data.

According to the above configuration, an image data-processing apparatus operable to encode image data rapidly into MPEG standard encoded data through the pipeline processing is provided.

An eighth aspect of the present invention provides an image data-processing apparatus in which the pipeline controller includes: a start-up table storage unit operable to contain a pipeline start-up table in which start-up information on control over the pipeline processing in the image data-encoding unit is registered; an offset-determining unit operable to determine an offset value for use in referencing the pipeline start-up table in the start-up table storage unit; a start-up stage-determining unit operable to read the start-up information from the pipeline start-up table in the start-up table storage unit in accordance with the offset value determined by the offset-determining unit, thereby determining a start-up method for the pipeline processing in the image data-encoding unit; and a pipeline control unit operable to control the offset-determining unit and the start-up stage-determining unit, thereby controlling the pipeline processing in the image data-encoding unit in accordance with the start-up method for the pipeline processing as determined by the start-up stage-determining unit.

According to the above configuration, the pipeline start-up table is referenced based on any offset value, thereby making it easy to start the processing units that practice the pipeline processing.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating an image data-processing apparatus according to a first embodiment of the present invention;

FIG. 2(a) is a diagram illustrating image-decoding process according to the first embodiment;

FIG. 2(b) is an illustration showing a decoded image according to the first embodiment;

FIG. 3 is a time chart illustrating pipeline processing according to the first embodiment;

FIG. 4 is a flowchart illustrating the anterior half of pipeline control according to the first embodiment;

FIG. 5 is a flowchart illustrating the posterior half of the pipeline control according to the first embodiment;

FIG. 6 is a flowchart illustrating the anterior half of pipeline start-up table referencing-adapted offset-determining process according to the first embodiment;

FIG. 7 is a flowchart illustrating the posterior half of the pipeline start-up table referencing-adapted offset-determining process according to the first embodiment;

FIG. 8 is a flowchart illustrating pipeline start-up stage-determining process according to the first embodiment;

FIG. 9(a) is a block diagram illustrating a pipeline start-up table according to the first embodiment;

FIG. 9(b) is a block diagram illustrating a pipeline interruption table according to the first embodiment;

FIG. 10 is a block diagram illustrating an image data-processing apparatus according to a second embodiment;

FIG. 11 is a time chart illustrating pipeline processing according to the second embodiment;

FIG. 12 is a flowchart illustrating the anterior half of pipeline control according to the second embodiment;

FIG. 13 is a flowchart illustrating the posterior half of the pipeline control according to the second embodiment;

FIG. 14 is a flowchart illustrating error concealment processing according to the second embodiment;

FIG. 15 is a block diagram illustrating an image data-processing apparatus according to a third embodiment;

FIG. 16 is a time chart illustrating pipeline processing according to the third embodiment; and

FIG. 17 is a block diagram illustrating a prior art image data-processing apparatus.

### BEST MODE FOR CARRYING OUT THE INVENTION

Embodiments of the present invention are now described with reference to the accompanying drawings.

### First Embodiment

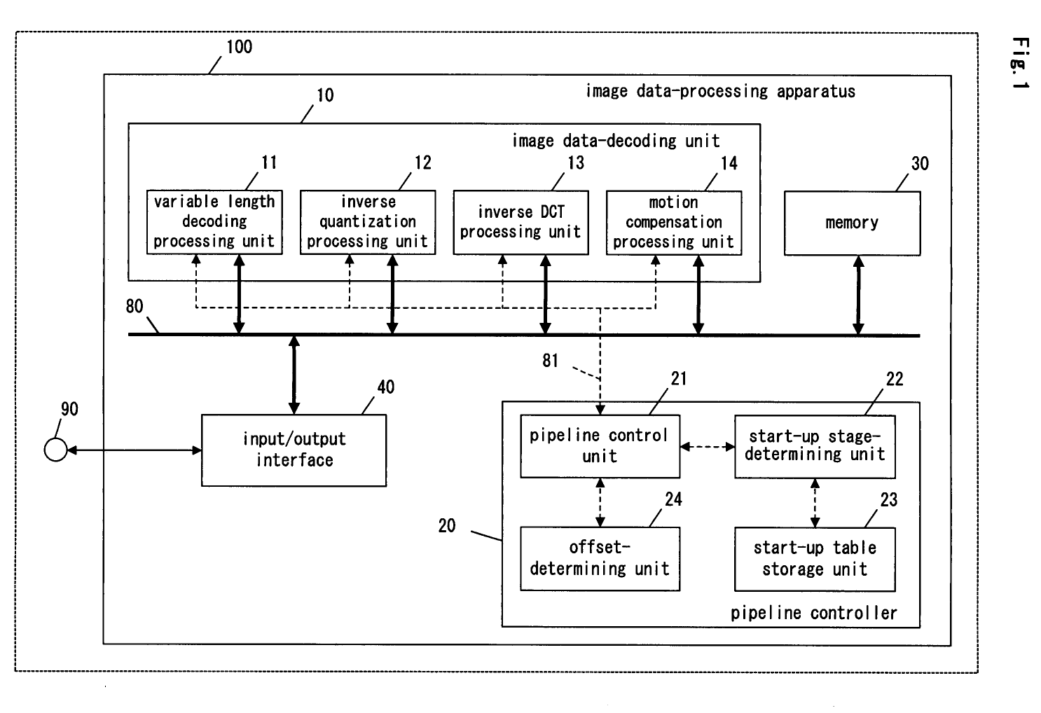

FIG. 1 is a block diagram illustrating an image data-processing apparatus 100 according to a first embodiment. The image data-processing apparatus 100 according to the present embodiment is operable to practice the pipeline processing-assisted, rapid decoding of encoded data that conforms to any moving image processing standard represented by the MPEG standard.

As shown in FIG. 1, the image data-processing apparatus 100 according to the present embodiment includes an image data-decoding unit 10, a pipeline controller 20, a memory 30, and an input/output interface 40. The image data-decoding unit 10 includes a variable length decoding processing unit 11, an inverse quantization processing unit 12, an inverse DCT processing unit 13, and a motion compensation processing unit 14. The pipeline controller 20 includes a pipeline control unit 21, a start-up stage-determining unit 22, a start-up table storage unit 23, and an offset-determining unit 24.

The variable length decoding processing unit 11, inverse quantization processing unit 12, inverse DCT processing unit 13, motion compensation processing unit 14, memory 30 and input/output interface 40 are connected to a data bus 80. The variable length decoding processing unit 11, inverse quantization processing unit 12, inverse DCT processing unit 13, and motion compensation processing unit 14 are connected to the pipeline control unit 21 through a control line 81.

The variable length decoding processing unit 11, inverse quantization processing unit 12, and inverse DCT processing unit 13 form pipeline stages, and provides what is called pipeline processing. The pipeline processing is controlled by the pipeline control unit 21 through the control line 81. Details of the pipeline processing and control thereof are discussed later.

Input encoded data (or input encoded data encoded into variable length codes according to the present embodiment) is at first stored by the memory 30 after being entered into the input/output interface 40 through an input/output port 90.

The variable length decoding processing unit 11 is operable to practice the variable length decoding of the stored input encoded data from the memory 30, thereby providing quantized DCT coefficients and motion vectors.

The inverse quantization processing unit 12 is operable to inversely quantize the quantized DCT coefficients from the variable length decoding processing unit 11, thereby providing inversely quantized DCT coefficients.

The inverse DCT processing unit 13 is operable to practice the inverse DCT processing of the inversely quantized DCT coefficients from the inverse quantization processing unit 12, thereby providing DCT coefficients.

The motion compensation processing unit 14 is operable to generate decoded image data of the present frame, using the motion vectors from the variable length decoding processing unit 11, the DCT coefficients from the inverse DCT processing unit 13, and stored decoded image data of a previous frame from the memory 30. The resulting decoded image data of the present frame are stored in the memory 30.

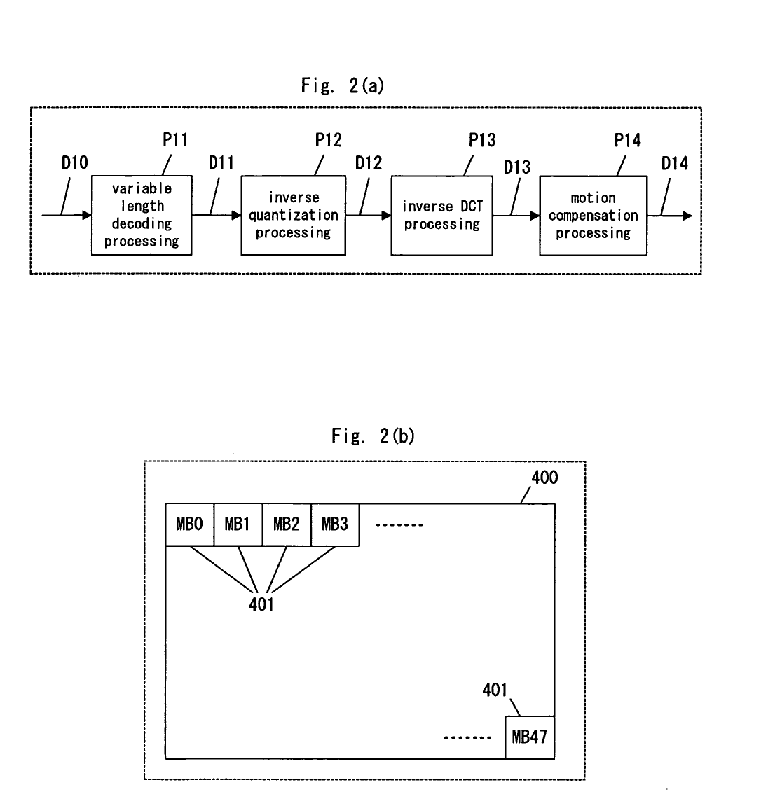

FIG. 2(a) is a diagram illustrating image-decoding process according to the present embodiment. More specifically, FIG. 2(a) illustrates a flow of image-decoding process to be executed by the image data-processing apparatus 100 according to the present embodiment.

The encoded data “D10” read out of the memory 30 is subjected by the variable length decoding processing unit 11 to variable length decoding processing “P11”, thereby providing quantized DCT coefficients “D11”.

The quantized DCT coefficients “D11” are subjected by the inverse quantization processing unit 12 to inverse quantization processing “P12”, thereby providing inversely quantized DCT coefficients “D12”.

The inversely quantized DCT coefficients “D12” are subjected by the inverse DCT processing unit 13 to inverse DCT processing “P13”, thereby providing DCT coefficients “D13”.

The DCT coefficients “D13” are subjected by the motion compensation processing unit 14 to motion compensation processing “P14”, thereby providing decoded image data “D14” of the present frame. The motion compensation processing “P14” employs the motion vectors from the variable length decoding processing “P11” and the stored decoded image data of the previous frame from the memory 30.

FIG. 2(b) is an illustration showing a decoded image 400 according to the present embodiment. The image-decoding process of FIG. 2(a) is executed for each partial image or macro block 401 of FIG. 2(b), which consists of MB0, MB1, MB2, and MB3 to MB47. In general, the image-decoding process starts with the macro block “MB0” at the upper-left corner of the decoded image, and is subsequently applied in turn to the rightward macro block (MB0→MB1→MB2 . . . →MB47).

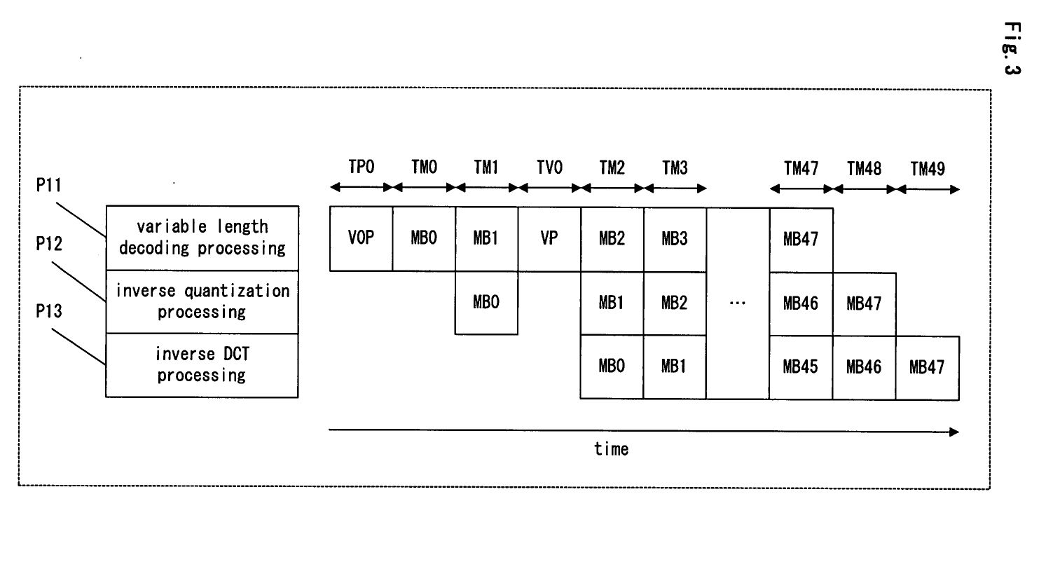

FIG. 3 is a time chart illustrating the pipeline processing according to the present embodiment. The pipeline processing according to the present embodiment is applied only to the variable length decoding processing “P11”, inverse quantization processing “P12”, and inverse DCT processing “P13” in the image-decoding process of FIG. 2(a) according to the present embodiment. The horizontal and vertical axes of FIG. 3 denote time elapse and image decoding process-related pipeline processing stages, respectively. In the image-decoding process, the pipeline processing stages of FIG. 3 include three stages: the first stage (S1) of the variable length decoding processing “P11”; the second stage (S2) of the inverse quantization processing “P12; and the third stage (S3) of the inverse DCT processing “P13”. No further details of the processing “P11”, “P12, “P13”, and “P14” are herein discussed because they are out of scope of the present invention.

The following discusses the pipeline processing of FIG. 3 according to the present embodiment.

Upon the start of the image-decoding process, at initial period “TP0”, frame header information “VOP” is subjected to the first stage variable length decoding processing “P11”. The frame header information “VOP”, inserted in each frame at the head thereof in variable length code data, contains information such as the number of in-frame macro blocks.

At the following period “TM0”, the first macro block “MB0” is subjected to the first stage variable length decoding processing “P11”.

After the completion of the processing “P11” during the period “TM0”, at period “TM1”, the second macro block “MB1” and the macro block “MB0” are subjected in parallel to the first stage variable length decoding processing “P11” and the second stage inverse quantization processing “P12”, respectively.

At the next period “TV0”, packet header information “VP” is subjected to the first stage variable length decoding processing “P11”. The packet header information “VP” contains information on packet headers appropriately inserted between pieces of macro block data and, more specifically, contains the macro block number of each of subsequent macro blocks, and a quantization value in each of the macro blocks for use in inverse quantization processing.

After the completion of the processing “P11” during the period “TV0”, at the next period “TM2”, the third macro block “MB2”, the macro block “MB1”, and the macro block “MB0” are subjected in parallel to the first stage variable length decoding processing “P11”, the second stage inverse quantization processing “P12”, and the third stage inverse DCT processing “P13”, respectively.

After the completion of the processing during the period “TM2”, at period “TM3”, the fourth macro block “MB3”, the macro block “MB2”, and the macro block “MB1” are subjected in parallel to the first stage variable length decoding processing “P11”, the second stage inverse quantization processing “P12”, and the third stage inverse DCT processing “P13”, respectively.

Similar processing is subsequently repeated for each of the macro blocks to be processed, until period “TM47” is reached, at which the final macro block “MB47” of the decoded image is subjected to the first stage variable length decoding processing “P11”. The number of the final macro block of the decoded image can be determined according to the number of the in-frame macro blocks, which is obtained at the period “TP0” by the decoding of the frame header information “VOP”.

After the completion of the processing during the period “TM47”, at period “TM48, the macro blocks “MB47” and “MB46” are subjected in parallel to the second stage inverse quantization processing “P12” and the third stage inverse DCT processing “P13”, respectively.

After the completion of the processing during the period “TM48”, at period “TM49”, the macro block “MB47” is subjected to the third stage inverse DCT processing “P13”. In this way, the pipeline processing to decode the present frame is completed.

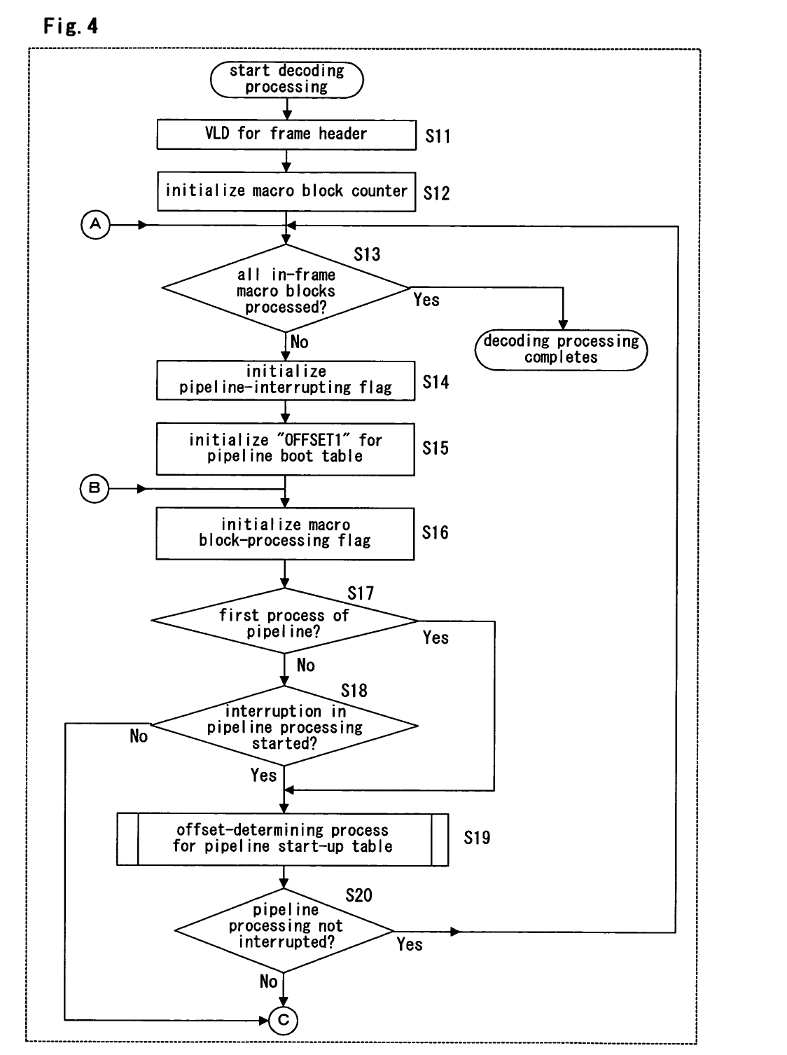

The following discusses, with reference to flowcharts of FIG. 4 to FIG. 8, how the pipeline control is practiced when the pipeline processing of FIG. 3 is executed in the image data-processing apparatus 100 of FIG. 1 according to the present embodiment. The pipeline control is practiced by the pipeline controller 20 of FIG. 1.

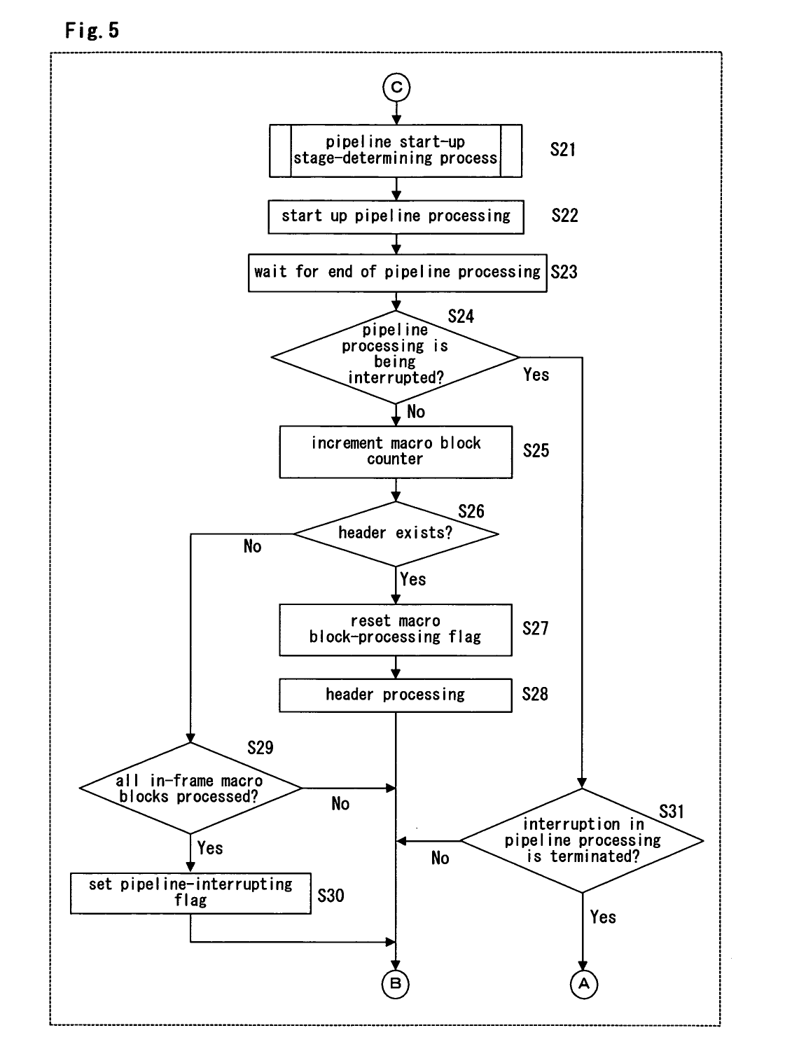

FIG. 4 is a flowchart illustrating the anterior half of the pipeline control according to the present embodiment. FIG. 5 is a flowchart illustrating the posterior half of the pipeline control according to the present embodiment. In FIG. 4, circled notations such as “A”, “B”, and “C” are linked to those of FIG. 5, respectively.

The following discusses the pipeline control according to the present embodiment in accordance with the flowchart of FIG. 4 for each of the periods as illustrated in FIG. 3.

### Period “TP0”

Referring to FIG. 4, upon the start of the image-decoding process, the pipeline control unit 21 in the pipeline controller 20 of FIG. 1 is activated.

At step “S11”, the pipeline control unit 21 operates the variable length decoding processing unit 11 to practice the variable length decoding (VLD) processing of the frame header information “VOP” in variable length encoded data, inserted in each frame at the head thereof, and thereby obtaining the number of the in-frame macro blocks (MB_IN_VOP). At the present period, it is assumed that the obtained number of the in-frame macro blocks (MB_IN_VOP) is equal to 48, as follows:

MB_IN_VOP=48.

At step “S12”, the pipeline control unit 21 initializes a macro block counter (MBA), thereby setting it as being equal to zero, as follows:

MBA=0.

At step “S13”, to determine whether all of the in-frame macro blocks have completely been processed, the pipeline control unit 21 determines whether MBA is equal or greater than MB_IN_VOP, as follows:

MBA>=MB_IN_VOP,

where the symbol “>=” denotes that the left-hand side is equal or greater than the right-hand side. At present,

MBA=0; and

MB_IN_VOP=48.

Therefore, the determination in step “S13” results in “NO”, which means that there are still remaining macro blocks to be processed. The routine is advanced to step “S14”.

### Period “TM0”

At step “S14”, the pipeline control unit 21 initializes a pipeline-interrupting flag (PIPE_END), thereby setting it as follows:

PIPE_END=0.

At step “S15”, the pipeline control unit 21 initializes an “OFFSET1”, thereby setting it as follows:

OFFSET1=0.

The OFFSET1 is used to reference a pipeline boot table as discussed later.

At step “S16”, the pipeline control unit 21 initializes a macro block-processing flag (MB_PROC), thereby setting it as follows:

MB_PROC=1.

At step “S17”, to determine whether the pipeline processing is the first process of the pipeline, the pipeline control unit 21 determines whether OFFSET1 is equal to zero, as follows:

OFFSET==0?,

where, the symbol “==” denotes “equality”. OFFSET1 is currently equal to zero (OFFSET1=0), and the determination in step “S17” results in “YES”, which means that the pipeline processing is the first process of the pipeline. The routine is advanced to step “S19”.

At step “S19”, the offset-determining unit 24 of FIG. 1 is activated to practice pipeline start-up table referencing-adapted offset-determining process. The offset-determining unit 24 determines offset values (OFFSET1, OFFSET2, and OFFSET3) for use in referencing a pipeline start-up table (a pipeline boot table and a pipeline interruption table). The pipeline start-up table is discussed later.

To activate the offset-determining unit 24, the pipeline-interrupting flag (PIPE_END), macro block-processing flag (MB_PROC), and OFFSET1 for use on the pipeline boot table as discussed later are delivered from the pipeline control unit 21 to the offset-determining unit 24. The parameters currently delivered from the pipeline control unit 21 to the offset-determining unit 24 are:

PIPE_END=0;

MB_PROC=1; and

OFFSET1=0.

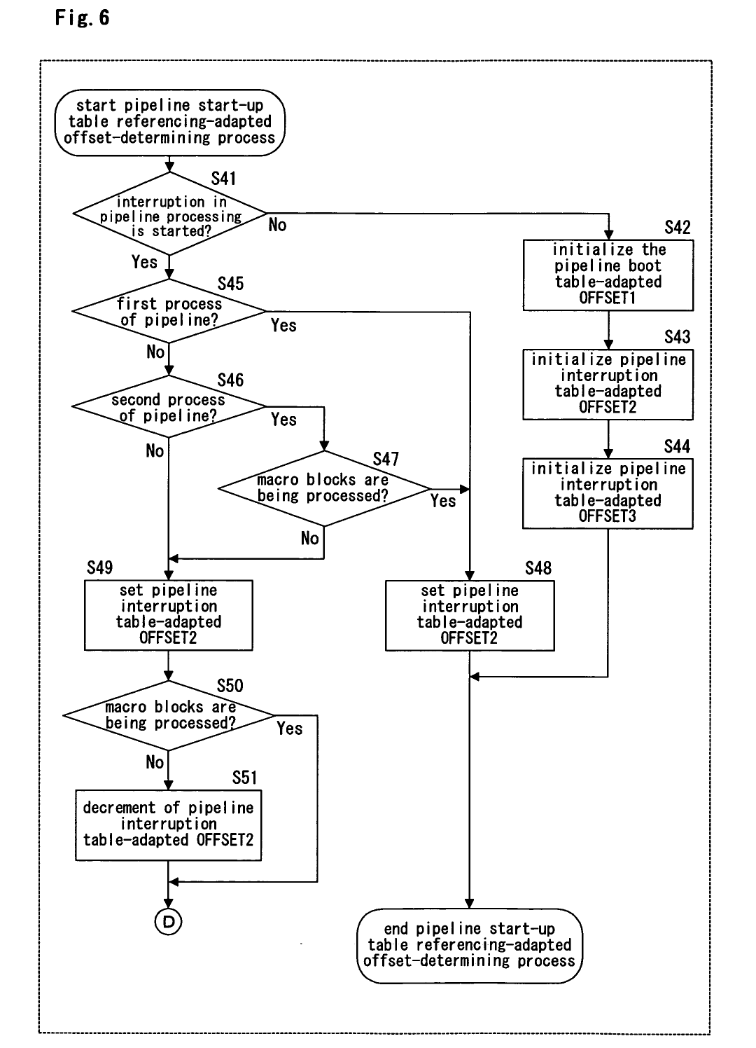

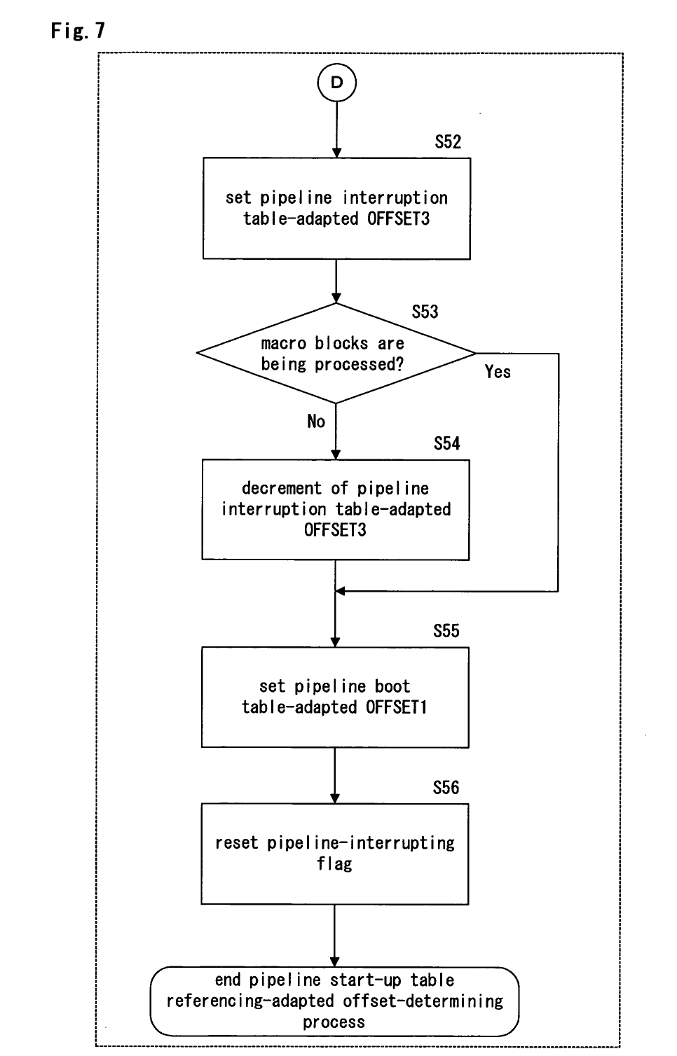

The pipeline start-up table referencing-adapted offset-determining process in step “S19” is more specifically illustrated by flowcharts of FIGS. 6 and 7. To be specific, FIG. 6 is the flowchart illustrating the anterior half of the pipeline start-up table referencing-adapted offset-determining process according to the present embodiment, while FIG. 7 is the flowchart illustrating the posterior half thereof. In FIG. 6, the circled notation “D” is linked to that of FIG. 7.

Upon the start of the pipeline start-up table referencing-adapted offset-determining process, at step “S41” of FIG. 6, the start-up table storage unit 23 of FIG. 1 is activated, and the offset-determining unit 24 determines whether an interruption in the pipeline processing is started. More specifically, the offset-determining unit 24 determines whether PIPE_END is unequal to zero, as follows:

PIPE_END!=0?,

where, the symbol “!=” denotes “inequality”.

PIPE_END is currently equal to zero (PIPE_END=0), and the determination in step “S41” results in “NO”, which means that no interruption in the pipeline processing is started. The routine is advanced to step “S42”.

At step “S42”, the offset-determining unit 24 initializes the pipeline boot table-adapted OFFSET1, thereby setting it as follows:

OFFSET1=0.

At step “S43”, the offset-determining unit 24 initializes the pipeline interruption table-adapted OFFSET2, thereby setting it as follows:

OFFSET2=0.

At step “S44”, the offset-determining unit 24 initializes the pipeline interruption table-adapted OFFSET3, thereby setting it as follows:

OFFSET3=−32768.

The offset-determining unit 24 practices the initialization during steps “S42”, “S43”, and “S44” as just discussed above, thereby terminating the pipeline start-up table referencing-adapted offset-determining process in step “S19” of FIG. 4.

At this time, the following parameters are returned from the offset-determining unit 24 to the pipeline control unit 21.

OFFSET1=0;

OFFSET2=0;

OFFSET3=−32768; and

PIPE_END=0

After the completion of the pipeline start-up table referencing-adapted offset-determining process in step “S19” of FIG. 4, the routine is advanced to step “S20”.

At step “S20”, to determine whether the pipeline processing is to be uninterrupted, the pipeline control unit 21 determines whether OFFSET2 is equal to −32768 by,

OFFSET2==−32768?

The pipeline interruption table-adapted OFFSET2 currently has the value of zero (OFFSET2=0), and the determination in step “S20” results in “NO”, which means that the pipeline processing is to be interrupted. The routine is advanced to step “S21” of FIG. 5.

At step “S21” of FIG. 5, the start-up stage-determining unit 22 of FIG. 1 is activated to practice pipeline start-up stage-determining process. More specifically, in the pipeline start-up stage-determining process in step “S21”, the start-up stage-determining unit 22 determines a pipeline stage start-up parameter (PIPEKICK) for use in activating the pipeline stages of: the variable length decoding processing “P11” to be practiced by the variable length decoding processing unit 11; the inverse quantization processing “P12” to be practiced by the inverse quantization processing unit 12; and the inverse DCT processing “P13” to be practiced by the inverse DCT processing unit 13.

To activate the start-up stage-determining unit 22, the pipeline boot table-adapted OFFSET1, the pipeline interruption table-adapted OFFSET2, and the pipeline interruption table-adapted OFFSET3 are delivered from the pipeline control unit 21 to the start-up stage-determining unit 22. The parameters currently delivered from the pipeline control unit 21 to the start-up stage-determining unit 22 are:

OFFSET1=0;

OFFSET2=0;

OFFSET3=−32768

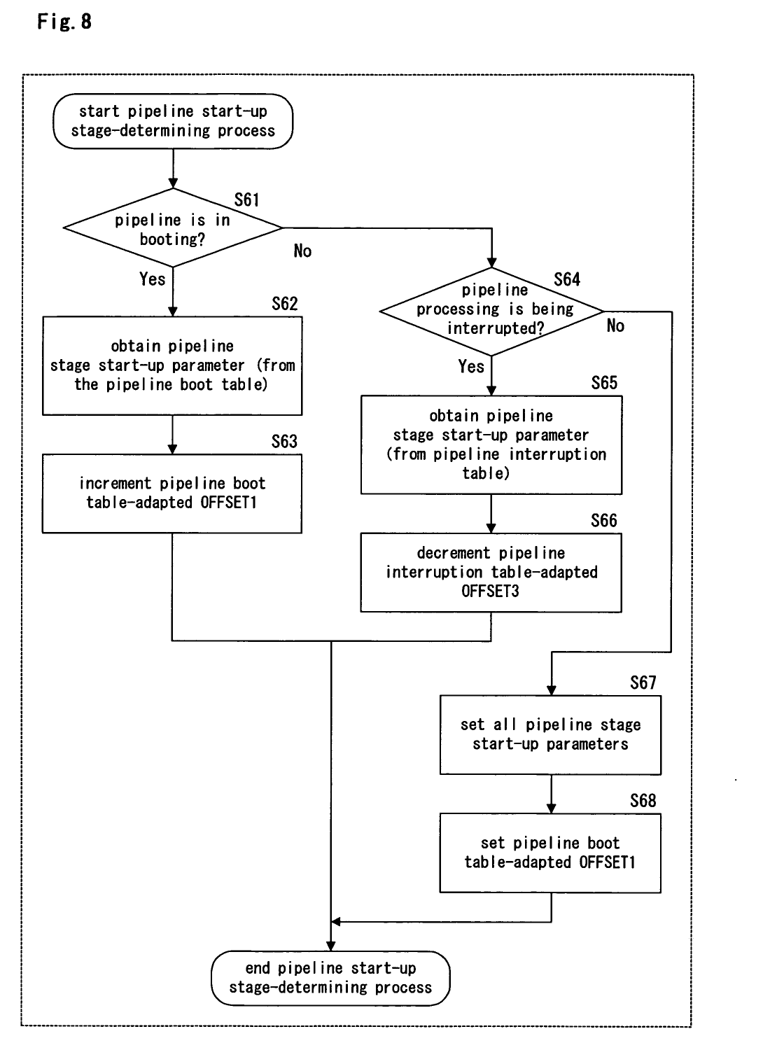

The pipeline start-up stage-determining process in step “S21” is more specifically illustrated by a flowchart of FIG. 8. To be specific, FIG. 8 is the flowchart illustrating the pipeline start-up stage-determining process according to the present embodiment. The following discusses the pipeline start-up stage-determining process with reference to FIG. 8.

Upon the start of the pipeline start-up stage-determining process, the start-up stage-determining unit 22 of FIG. 1 is activated. At step “S61”, to determine whether the pipeline is in booting, the start-up stage-determining unit 22 determines whether OFFSET1 is smaller than two, as follows:

OFFSET1<2?

OFFSET1 is currently equal to zero (OFFSET1=0), and the determination in step “S61” results in “YES”, which means that the pipeline is being booted. The routine is advanced to step “S62”.

At step “S62”, the start-up stage-determining unit 22 obtains the pipeline stage start-up parameter (PIPEKICK) from the pipeline boot table (TABLE1). More specifically, the start-up stage-determining unit 22 references the pipeline boot table (TABLE1) using the pipeline boot table-adapted OFFSET1, thereby calculating the following:

PIPEKICK=TABLE1 [OFFSET1].

The pipeline boot table (TABLE1), placed in the start-up table storage unit 23, contains respective pieces of start-up information on the variable length decoding processing unit 11, inverse quantization processing unit 12, and inverse DCT processing unit 13.

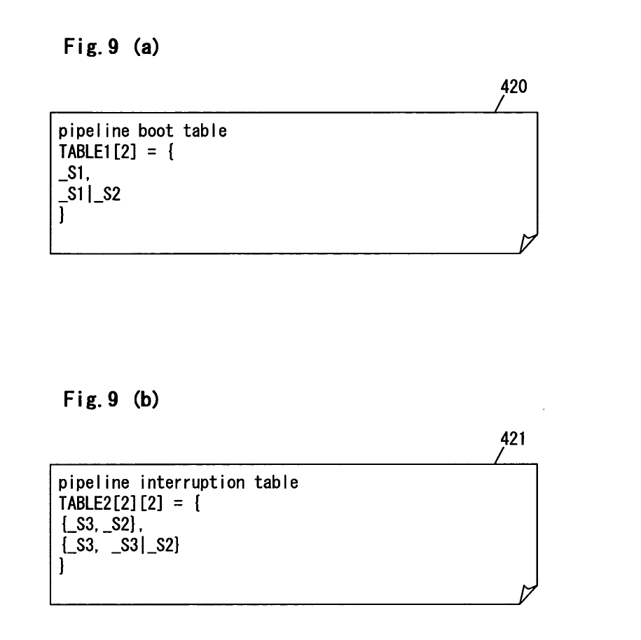

FIG. 9(a) is a block diagram illustrating the pipeline boot table (TABLE1) 420 according to the present embodiment. FIG. 9(b) is a block diagram illustrating the pipeline interruption table (TABLE2) 421 according to the present embodiment.

The pipeline boot table (TABLE1) 420 includes two different elements of “_S1” and “_S1|_S2”. The element “_S1” denotes the start-up of the first stage (S1) variable length decoding processing “P11” in the pipeline processing. While, the element “_S1|_S2” denotes the parallel start-up of the first stage (S1) variable length decoding processing “P11” and the second stage (S2) inverse quantization processing “P12”.

At step “S62” of FIG. 8, OFFSET1 is equal to zero (OFFSET1=0), and the start-up stage-determining unit 22 obtains the pipeline stage start-up parameter (PIPEKICK) from the pipeline boot table 420, as follows:

PIPEKICK=_S1.

At the next step “S63”, to increment the pipeline boot table-adapted OFFSET1, the start-up stage-determining unit 22 executes as follows:

OFFSET1++,

where, the symbol “++” denotes the addition of the value one (1) to a variable of the left-hand side, thereby setting OFFSET1 as follows:

OFFSET1=1.

Thereby, the pipeline start-up stage-determining process is terminated.

Upon the termination of the pipeline start-up stage-determining process in the start-up stage-determining unit 22, the pipeline boot table-adapted OFFSET1, pipeline interruption table-adapted OFFSET2, pipeline interruption table-adapted OFFSET3, and pipeline stage start-up parameter (PIPEKICK) are returned to the pipeline control unit 21 from the start-up stage-determining unit 22. The parameters returned from the start-up stage-determining unit 22 to the pipeline control unit 21 are:

OFFSET1=1;

OFFSET2=0;

OFFSET3=−32768; and

PIPEKICK=_S1.

Now, the pipeline start-up stage-determining process in step “S21” of FIG. 5 is terminated. The routine is advanced to step “S22” of FIG. 5.

At step “S22”, the pipeline control unit 21 starts up the pipeline processing. The pipeline processing in step “S22” is started up in accordance with the pipeline stage start-up parameter (PIPEKICK) as determined in step “S21”. More specifically, the pipeline control unit 21 activates a processing unit respondent to each pipeline stage set in the pipeline stage start-up parameter (PIPEKICK). The pipeline stage start-up parameter (PIPEKICK) is currently equal to “_S1” (PIPEKICK=_S1), thereby activating only the variable length decoding processing unit 11 designed for the first stage (S1) variable length decoding processing “P11”.

At step “S23”, the pipeline control unit 21 waits for the end of the variable length decoding processing “P11” started up in step “S22”. Upon the termination of the processing, the routine is advanced to step “S24”.

At step “S24”, to determine whether the pipeline processing is being interrupted, the pipeline control unit 21 determines whether OFFSET3 is unequal to −32768, as follows:

OFFSET3!=−32768?

OFFSET3 is currently equal to −32768 (OFFSET3=−32768), and the determination in step “S24” results in “NO”, which means that the pipeline processing is not being interrupted. The routine is advanced to step “S25”.

At step “S25”, to increment the macro block counter (MBA), the pipeline control unit 21 makes the following calculation:

MBA++,

thereby setting MBA as follows:

MBA=1.

At the next step “S26”, the pipeline control unit 21 determines whether the header is present.

The variable length code data contains a synchronous word at the head of the packet header information “VP” inserted between pieces of macro block data. The synchronous word includes a specific bit string such as “0x00000”, in which the character “x” denotes the value of either “0” or “1”. The detection of the synchronous word determines whether the head is present.

The determination in step “S26” results in “NO”, which means that the header is absent. The routine is advanced to step “S29”.

At step “S29”, to determine whether all of the in-frame macro blocks have completely been processed, the pipeline control unit 21 determines whether MBA is equal or greater than MB_IN_VOP, as follows:

MBA>=MB_IN_VOP?

At present, MBA and MB_IN_VOP are defined as follows:

MBA=1; and

MB_IN_VOP=48.

Therefore, the determination in step “S29” results in “NO”, which means that there are still remaining macro blocks to be processed. The routine is directly returned to step “S16” of FIG. 4 to start processing at the next period.

Now, the processing during the period “TM0” is terminated.

### Period TM1, TV0

The processing at the present period starts with step “S16” of FIG. 4.

At the beginning of the present period, major parameters are set as given below.

MBA=1;

PIPE_END=0;

MB_PROC=1;

OFFSET1=1;

OFFSET2=0; and

OFFSET3=−32768.

At step “S16”, the pipeline control unit 21 initializes the macro block-processing flag (MB_PROC), as follows:

MB_PROC=1.

At step “S17”, to determine whether the pipeline processing is the first process of the pipeline, the pipeline control unit 21 determines whether OFFSET1 is equal to zero, as follows:

OFFSET==0?

OFFSET1 is currently equal to one (OFFSET1=1), and the determination in step “S17” results in “NO”, which means that the pipeline processing is not the first process of the pipeline. The routine is advanced to step “S18”.

At step “S18”, to determine whether an interruption in the pipeline processing is started, the pipeline control unit 21 determines whether PIPE_END is unequal to zero, as follows:

PIPE_END!=0.

PIPE_END is currently equal to zero (PIPE_END=0), and the determination in step “S18” results in “NO”, which means that no interruption in the pipeline processing is started. The routine is advanced to step “S21” of FIG. 5.

At step “S21” of FIG. 5, the start-up stage-determining unit 22 is activated. At this time, parameters as given below are delivered from the pipeline control unit 21 to the start-up stage-determining unit 22, thereby executing the pipeline start-up stage-determining process of FIG. 8.

OFFSET1=1;

OFFSET2=0; and

OFFSET3=−32768.

At step “S61” of FIG. 8, to determine whether the pipeline is in booting, the start-up stage-determining unit 22 determines whether OFFSET1 is smaller than two, that is:

OFFSET1<2?

OFFSET1 is currently equal to 1 (OFFSET1=1), and the determination in step “S61” results in “YES”, which means that the pipeline is being booted. The routine is advanced to step “S62”.

At step “S62”, the start-up stage-determining unit 22 references the pipeline boot table 420 using “OFFSET1=1”, and calculates as follows:

PIPEKICK=TABLE1 [OFFSET1],

thereby obtaining the pipeline stage start-up parameter (PIPEKICK), as follows:

PIPEKICK=_S1|_S2”.

At step “S63”, the start-up stage-determining unit 22 calculates the following:

OFFSET1++”,

thereby setting OFFSET1 as follows:

OFFSET1=2”.

Now, the pipeline start-up stage-determining process is terminated.

As a result, at the end of the pipeline start-up stage-determining process, parameters as given below are returned to the pipeline control unit 21 from the start-up stage-determining unit 22.

OFFSET1=2;

OFFSET2=0;

OFFSET3=−32768; and

PIPEKICK=_S1|_S2.

At the next step “S22” of FIG. 5, the pipeline control unit 21 starts up the pipeline processing. In the start-up of the pipeline processing in step “S22”, the pipeline processing stages of both of the first stage (S1) variable length decoding processing “P11” and the second stage (S2) inverse quantization processing “P12” are started up in parallel in accordance with the element “_S1|_S2” set in the pipeline stage start-up parameter (PIPEKICK).

At step “S23”, the pipeline control unit 21 waits for the end of the parallel started-up variable length decoding processing “P11” and inverse quantization processing “P12”.

At step “S24”, to determine whether the pipeline processing is being interrupted, the pipeline control unit 21 determines whether OFFSET3 is unequal to −32768, that is:

OFFSET3!=−32768?

OFFSET3 is currently equal to −32768 (OFFSET3=−32768), and the determination in step “S24” results in “NO”, which means that the pipeline processing is not being interrupted. The routine is advanced to step “S25”.

At step “S25”, the pipeline control unit 21 calculates MBA as follows:

MBA++,

thereby setting MBA as follows:

MBA=2.

At step “S26”, a determination is made as to whether the header is present. The determination in step “S26” is assumed to result in “YES”, which means that the header is present. The routine is advanced to step “S27”.

At step “S27”, to reset the macro block-processing flag (MB_PROC), the pipeline control unit 21 sets MB_PROC as follows:

MB_PROC=0.

At step “S28”, the header is processed.

Now, the processing during the periods “TM1” and “TV0” is terminated. The routine is returned to step “S16” of FIG. 4.

### Period “TM2”

The processing at the present period starts with step “S16 of FIG. 4.

At the beginning of the present period, major parameters are set as given below.

MBA=2;

PIPE_END=0;

MB_PROC=1;

OFFSET1=2;

OFFSET2=0; and

OFFSET3=−32768.

At step “S16”, the pipeline control unit 21 initializes the macro block-processing flag (MB_PROC), thereby setting it as follows:

MB_PROC=1.

At step “S17”, to determine whether the pipeline processing is the first process of the pipeline, the pipeline control unit 21 determines whether OFFSET1 is equal to zero, such that:

OFFSET1==0?

OFFSET1 is currently equal to two (OFFSET1=2), and the determination in step “S17” results in “NO”, which means that the pipeline processing is not the first process of the pipeline. The routine is advanced to step “S18”.

At step “S18”, to determine whether an interruption in the pipeline processing is started, the pipeline control unit 21 determines whether PIPE_END is unequal to zero, as follows:

PIPE_END!=0?

PIPE_END is currently equal to zero (PIPE_END=0), and the determination in step “S18” results in “NO”, which means that no interruption in the pipeline processing is started. The routine is advanced to step “S21” of FIG. 5.

At step “S21” of FIG. 5, the start-up stage-determining unit 22 is activated. At this time, parameters as given below are delivered from the pipeline control unit 21 to the start-up stage-determining unit 22, thereby practicing the pipeline start-up stage-determining process of FIG. 8.

OFFSET1=2;

OFFSET2=0; and

OFFSET3=−32768.

At step “S61” of FIG. 8, to determine whether the pipeline is in booting, a determination is made as to whether OFFSET1 is smaller than two, such that:

OFFSET1<2?

OFFSET1 is currently equal to two (OFFSET1=2), and the determination in step “S61” results in “NO”, which means that the pipeline is not being booted. The routine is advanced to step “S64”.

At step “S64”, to determine whether the pipeline processing is being interrupted, the start-up stage-determining unit 22 determines whether OFFSET3 is equal or greater than zero, that is:

OFFSET3 >=0?

OFFSET3 is currently equal to −32768 (OFFSET3=−32768), and the determination in step “S64” results in “NO”, which means that the pipeline processing is not being interrupted. The routine is advanced to step “S67”.

At step “S67”, to activate all of the pipeline stages, the start-up stage-determining unit 22 sets the pipeline stage start-up parameter (PIPEKICK), such that:

PIPEKICK=_S1|_S2|_S3.

In the pipeline processing, the element “_S1|_S2|_S3” denotes the parallel start-up of the first stage (S1) variable length decoding processing “P11”, the second stage (S2) inverse quantization processing “P12”, and the third stage (S3) inverse DCT processing “P13”.

At step “S68”, the start-up stage-determining unit 22 sets a maximum positive value into the pipeline boot table-adapted OFFSET1, as follows:

OFFSET1=32767.

Now, the pipeline start-up stage-determining process is terminated.

At the end of the pipeline start-up stage-determining process, parameters as given below are returned to the pipeline control unit 21 from the start-up stage-determining unit 22.

OFFSET1=32767;

OFFSET2=0;

OFFSET3=−32768; and

PIPEKICK=_S1|_S2|_S3.

Referring now back to FIG. 5, at step “S22”, the pipeline control unit 21 starts up the pipeline processing. In the start-up of the pipeline processing in step “S22”, all of the pipeline processing stages, i.e., the first stage (S1) variable length decoding processing “P11”, the second stage (S2) inverse quantization processing “P12”, and the third stage (S3) inverse DCT processing “P13” are activated in parallel in accordance with the element “_S1|_S2|_S3” set in the pipeline stage start-up parameter (PIPEKICK).

At step “S23”, the pipeline control unit 21 waits for the end of the parallel activated variable length decoding processing “P11”, inverse quantization processing “P12”, and inverse DCT processing “P13”.

At the next step “S24”, to determine whether the pipeline processing is being interrupted, the pipeline control unit 21 determines whether OFFSET3 is unequal to −32768, as follows:

OFFSET3!=−32768?

OFFSET3 is currently equal to −32768 (OFFSET3=−32768), and the determination in step “S24” results in “NO”, which means that the pipeline processing is not being interrupted. The routine is advanced to step “S25”.

At step “S25”, the pipeline control unit 21 makes calculation as follows:

MBA++,

thereby setting MBA as follows:

MBA=3.

At the next step “S26”, a determination is made as to whether the header is present. The determination in the present step is assumed to result in “NO”, which means that the header is absent. The routine is advanced to step “S29”.

At step “S29”, to determine whether all of the in-frame macro blocks have completely been processed, the pipeline control unit 21 determines whether MBA is equal or greater than MB_IN_VOP, such that:

MBA>=MB_IN_VOP?

At present, MBA and MB_IN_VOP are defined as follows:

MBA=3; and

MB_IN_VOP=48,

therefore, the determination in step “S29” results in “NO”, which means that there are still remaining macro blocks to be processed. Now, the processing during the period “TM2” is terminated. The routine is returned to step “S16” to start processing at the next period.

### Period “TM3” to “TM46”

The processing during the present periods is essentially the same as that during the period “TM2” as discussed above, and descriptions related thereto are herein omitted.

### Period “TM47”

The processing at the present period starts with step “S16 of FIG. 4.

At the beginning of the present period, major parameters are set as given below.

MBA=47;

PIPE_END=0;

MB_PROC=1;

OFFSET1=32767;

OFFSET2=0;

OFFSET3=−32768.

At step “S16”, the pipeline control unit 21 initializes the macro block-processing flag (MB_PROC), as follows:

MB_PROC=1.

At step “S17”, to determine whether the pipeline processing is the first process of the pipeline, the pipeline control unit 21 determines whether OFFSET1 is equal to zero, as follows:

OFFSET1=0==?

OFFSET1 is currently equal to 32767 (OFFSET1=32767), and the determination in step “S17” results in “NO”, which means that the pipeline processing is not the first process of the pipeline. The routine is advanced to step “S18.

At step “S18”, to determine whether an interruption in the pipeline processing is started, the pipeline control unit 21 determines whether PIPE_END is unequal to zero, as follows:

PIPE_END!=0?

PIPE_END is currently equal to zero (IPE_END=0), and the determination in step “S18” results in “NO”, which means that no interruption in the pipeline processing is started. The routine is advanced to step “S21” of FIG. 5.

At step “S21” of FIG. 5, the start-up stage-determining unit 22 is activated. At this time, parameters as discussed below are delivered from the pipeline control unit 21 to the start-up stage-determining unit 22, thereby practicing the pipeline start-up stage-determining process of FIG. 8.

OFFSET1=32767;

OFFSET2=0; and

OFFSET3=−32768.

At step “S61 of FIG. 8, to determine whether the pipeline is in booting, a determination is made as to whether OFFSET1 is smaller than two, as follows:

OFFSET1<2?

OFFSET1 is currently equal to 32767 (OFFSET1=32767), and the determination in step “S61” results in “NO”, which means that the pipeline is not being booted. The routine is advanced to step “S64”.

At step “S64”, to determine whether the pipeline processing is being interrupted, the start-up stage-determining unit 22 determines whether OFFSET3 is equal or greater than zero, as follows:

OFFSET3 >=0?

OFFSET3 is currently equal to −32768 (OFFSET3=−32768), and the determination in step “S64” results in “NO”, which means that the pipeline processing is not being interrupted. The routine is advanced to step “S67”.

At step “S67”, to activate all of the pipeline stages, the start-up stage-determining unit 22 sets the pipeline stage start-up parameter (PIPEKICK), such that:

PIPEKICK=_S1|_S2|_S3.

At step “S68”, the start-up stage-determining unit 22 sets a maximum positive value into the pipeline boot table-adapted OFFSET1, as follows:

OFFSET1=32767.

Now, the pipeline start-up stage-determining process is terminated.

At the end of the pipeline start-up stage-determining process, parameters as discussed below are returned to the pipeline control unit 21 from the start-up stage-determining unit 22.

OFFSET1=32767;

OFFSET2=0;

OFFSET3=−32768; and

PIPEKICK=_S1|_S2|_S3.

At step “S22” of FIG. 5, the pipeline control unit 21 starts up the pipeline processing. In the start-up of the pipeline processing in step “S22”, all of the pipeline processing stages of the first stage (S1) variable length decoding processing “P11”, the second stage (S2) inverse quantization processing “P12”, and the third stage (S3) inverse DCT processing “P13” are activated in parallel in accordance the element “_S1|_S2|_S3” set in the pipeline stage start-up parameter (PIPEKICK).

At step “S23”, the pipeline control unit 21 waits for the end of the parallel activated variable length decoding processing “P11”, inverse quantization processing “P12”, and inverse DCT processing “P13”.

At the next step “S24”, to determine whether the pipeline processing is being interrupted, the pipeline control unit 21 determines whether OFFSET3 is unequal to −32768, such that:

OFFSET3!=−32768?

OFFSET3 is currently equal to −32768 (OFFSET3=−32768), and the determination in step “S24” results in “NO”, which means that the pipeline processing is not being interrupted. The routine is advanced to step “S25”.

At step “S25”, the pipeline control unit 21 makes calculation as follows

MBA++,

thereby setting MBA as follows:

MBA=48.

At the next step “S26”, a determination is made as to whether the header is present. The determination in the present step is assumed to result in “NO”, which means that the header is absent. The routine is advanced to step “S29”.

At step “S29”, to determine whether all of the in-frame macro blocks have completely been processed, the pipeline control unit 21 determines whether MBA is equal or greater than MB_IN_VOP, as follows:

MBA>=MB_IN_VOP?

At present, MBA and MB_IN_VOP are defined as follows:

MBA=48; and

MB_IN_VOP=48,

therefore, the determination in step “S29” results in “YES”, which means that all of the in-frame macro blocks have completely been processed. The routine is advanced to step “S30”.

At step “S30”, the pipeline control unit 21 sets the pipeline-interrupting flag (PIPE_END), as follows:

PIPE_END=1.

Now, the processing during the present period “TM47” is terminated, and the routine is returned to step “S16” to start processing at the next period.

### Period “TM48”

The processing during the present period starts with step “S16” of FIG. 4.

At the beginning of the present period, major parameters are set as given below.

MBA=48;

PIPE_END=1;

MB_PROC=1;

OFFSET1=32767;

OFFSET2=0; and

OFFSET3=−32768.

At step “S16”, to initialize the macro block-processing flag (MB_PROC), the pipeline control unit 21 sets it as follows:

MB_PROC=1.

At step “S17”, to determine whether the pipeline processing is the first process of the pipeline, the pipeline control unit 21 determines whether OFFSET1 is equal to zero, as follows:

OFFSET==0?

OFFSET1 is currently equal to 32767 (OFFSET1=32767), and the determination in step “S17” results in “NO”, which means that the pipeline processing is not the first process of the pipeline. The routine is advanced to step “S18.

At step “S18”, to determine whether an interruption in the pipeline processing is started, the pipeline control unit 21 determines whether PIPE_END is unequal to zero, as follows:

PIPE_END!=0?

PIPE_END is currently equal to one (PIPE_END=1), and the determination in step “S18” results in “YES”, which means that the interruption in the pipeline processing is started. The routine is advanced to step “S19”.

At step “S19”, the pipeline start-up table referencing-adapted offset-determining process is executed. More specifically, the processing according to the flowcharts of FIGS. 6 and 7 is executed, which illustrate the anterior half of the pipeline start-up table referencing-adapted offset-determining process and the posterior half thereof, respectively.

At this time, parameters as discussed below are delivered to the offset-determining unit 24 from the pipeline control unit 21.

PIPE_END=1;

MB_PROC=1; and

OFFSET1=32767.

Upon the start of the pipeline start-up table referencing-adapted offset-determining process of FIG. 6, at step “S41”, a determination is made as to whether an interruption in the pipeline processing is started. More specifically, the offset-determining unit 24 determines whether PIPE_END is unequal to zero, as follows:

PIPE_END!=0?

PIPE_END is currently equal to one (PIPE_END=1), and the determination in step “S41” results in “YES”, which means that the interruption in the pipeline processing is started. The routine is advanced to step “S45”.

At step “S45”, to determine whether the pipeline processing is the first process of the pipeline, the offset-determining unit 24 determines whether OFFSET1 is equal to zero, as follows:

OFFSET1==0?

OFFSET1 is currently equal to 32767 (OFFSET1=32767), and the determination in step “S45” results in “NO”, which means that the pipeline processing is not the first process of the pipeline. The routine is advanced to step “S46”.

At step “S46”, to determine whether the pipeline processing is the second process of the pipeline, the offset-determining unit 24 determines whether OFFSET1 is equal to one, as follows:

OFFSET1==1?

OFFSET1 is currently equal to 32767 (OFFSET1=32767), and the determination in step “S46” results in NO”, which means that the pipeline processing is not the second process of the pipeline. The routine is advanced to step “S49”.

At step “S49”, to set the pipeline interruption table-adapted OFFSET2, the offset-determining unit 24 makes calculation as follows:

OFFSET2=MIN (OFFSET1, 1).

In the above formula, the function MIN (x, y) means that a smaller variable value between the variables “x” and “y” is used as a function value.

OFFSET1 is currently equal to 32767 (OFFSET1=32767), and the calculation results in “OFFSET2=1”.

At the next step “S50”, to determine whether the macro blocks are being processed, the offset-determining unit 24 determines whether MB_PROC is unequal to zero, as follows:

MB_PROC!=0?

MB_PROC is currently equal to one (MB_PROC=1), and the determination in step “S50” results in “YES”, which means that the macro blocks are being processed. The routine is advanced to step “S52” of FIG. 7.

At step “S52” of FIG. 7, to set the pipeline interruption table-adapted OFFSET3, the offset-determining unit 24 sets OFFSET3 as follows:

OFFSET3=1,

The routine is advanced to step “S53”.

At step “S53”, to determine whether the macro blocks are being processed, the offset-determining unit 24 determines whether MB_PROC is unequal to zero, as follows:

MB_PROC!=0?

MB_PROC is currently equal to one (MB_PROC=1), and the determination in step “S53” results in “YES”, which means that the macro blocks are being processed. The routine is advanced to step “S55”.

At step “S55”, to set the pipeline boot table-adapted OFFSET1, the offset-determining unit 24 sets OFFSET1 as being equal to 32767, as follows:

OFFSET1=32767,

then, the routine is advanced to step “S56”.
At step “56”, to reset the pipeline-interrupting flag, the offset-determining unit 24 sets PIPE_END as follows:

PIPE_END=0.

After the end of the above settings, the offset-determining unit 24 terminates the pipeline start-up table referencing-adapted offset-determining process in step “S19” of FIG. 4. At this time, parameters as given below are returned to the pipeline control unit 21 from the offset-determining unit 24.

OFFSET1=32767;

OFFSET2=1;

OFFSET3=1; and

PIPE_END=0.

The routine is advanced to step “S20” of FIG. 4. To determine whether the pipeline processing is to be uninterrupted, the pipeline control unit 21 determines whether OFFSET2 is equal to −32768, as follows:

OFFSET2==−32768?

OFFSET2 is currently equal to one (OFFSET=1), and the determination in step “S20” results in “NO”, which means that the pipeline processing is to be interrupted. The routine is advanced to step “S21” of FIG. 5.

At step “S21”, the start-up stage-determining unit 22 is activated. At this time, parameters as discussed below are delivered from the pipeline control unit 21 to the start-up stage-determining unit 22, thereby practicing the pipeline start-up stage-determining process of FIG. 8.

OFFSET1=32767;

OFFSET2=1; and

OFFSET3=1.

At step “S61” of FIG. 8, to determine whether the pipeline is in booting, the start-up stage-determining unit 22 determines whether OFFSET1 is smaller than two, as follows:

OFFSET1<2?

OFFSET1 is currently equal to 32767 (OFFSET1=32767), and the determination in step “S61” results in “NO”. This means that the pipeline is not being booted. The routine is advanced to step “S64.

At step “S64”, to determine whether the pipeline processing is being interrupted, the start-up stage-determining unit 22 determines whether OFFSET3 is equal or greater than zero, as follows:

OFFSET3 >=0?

OFFSET3 is currently equal to one (OFFSET3=1), and the determination in step “S64” results in “YES”, which means that the pipeline processing is being interrupted. The routine is advanced to step “S65”.

At step “S65”, the start-up stage-determining unit 22 calculates the pipeline stage start-up parameter (PIPEKICK), as follows:

PIPEKICK=TABLE2 [OFFSET2][OFFSET3],

thereby obtaining the parameter from the pipeline interruption table 420, as follows:

PIPEKICK=_S2|_S3.

The routine is advanced to step “S66”.

At step “S66”, to decrement the pipeline interruption table-adapted OFFSET3, the start-up stage-determining unit 22 makes calculation as follows:

OFFSET3−−

where, the symbol “−−” denotes a reduction by only one in variable value of the left-hand side, thereby setting OFFSET3, as follows:

OFFSET3=0.

Now, the pipeline start-up stage-determining process is terminated. At this time, parameters as discussed below are returned to the pipeline control unit 21 from the start-up stage-determining unit 22.

OFFSET1=32767;

OFFSET2=1;

OFFSET3=0; and

PIPEKICK=_S2|_S3.

The routine is advanced to step “S22” of FIG. 5 to start up the pipeline processing. The pipeline processing in step “S22” is started up based on the pipeline stage start-up parameter “PIPEKICK=_S2|_S3” as determined in step “S21”. As a result, the second stage (S2) inverse quantization processing “P12” and the third stage (S3) inverse DCT processing “P13” are activated in parallel.

At the next step “S23”, the pipeline control unit 21 waits for the end of the inverse quantization processing “P12” and inverse DCT processing “P13”. At step “S24”, to determine whether the pipeline processing is being interrupted, the pipeline control unit 21 determines whether OFFSET3 is unequal to −32768, as follows:

OFFSET3!=−32768?

OFFSET3 is currently equal to zero (OFFSET3=0), and the determination in step “S24” results in “YES”, which means that the pipeline processing is being interrupted. The routine is advanced to step “S31”.
At step “S31”, to determine whether the interruption in the pipeline processing has been terminated, the pipeline control unit 21 determines whether OFFSET3 is equal to minus one, as follows:

OFFSET3==−1?

OFFSET3 is currently equal to zero (OFFSET3=0), and the determination in step “S24” results in “NO”, which means that the interruption in the pipeline processing is still in progress. Now, the processing during the present period “TM48” is terminated, and the routine is returned to step “S16” of FIG. 4.

### Period “TM49”

The processing at the present period starts with step “S16” of FIG. 4.

At the beginning of the present period, major parameters are set as given below.

MBA=48;

PIPE_END=0;

MB_PROC=1;

OFFSET1=32767;

OFFSET2=1; and

OFFSET3=0.

At step “S16”, to initialize the macro block-processing flag (MB_PROC), the pipeline control unit 21 sets it as follows:

MB_PROC=1.

At step “S17”, to determine whether the pipeline processing is the first process of the pipeline, the pipeline control unit 21 determines whether OFFSET1 is equal to zero, as follows:

OFFSET=0?

OFFSET1 is currently equal to 32767 (OFFSET1=32767), and the determination in step “S17” results in “NO”, which means that the pipeline processing is not the first process of the pipeline. The routine is advanced to step “S18.

At step “S18”, to determine whether an interruption in the pipeline processing is started, the pipeline control unit 21 determines whether PIPE_END is unequal to zero, as follows:

PIPE_END!=0?

PIPE_END is currently equal to zero (PIPE_END=0), and the determination in step “S18” results in “NO”, which means that no interruption in the pipeline processing is started. The routine is advanced to step “S21” of FIG. 5.

At step “S21” of FIG. 5, the start-up stage-determining unit 22 is activated. At this time, parameters as discussed below are delivered from the pipeline control unit 21 to the start-up stage-determining unit 22, thereby practicing the pipeline start-up stage-determining process of FIG. 8.

OFFSET1=32767;

OFFSET2=1; and

OFFSET3=0.

At step “S61” of FIG. 8, to determine whether the pipeline is in booting, the start-up stage-determining unit 22 determines whether OFFSET1 is smaller than two, as follows:

OFFSET1<2?

OFFSET1 is currently equal to 32767 (OFFSET1=32767), and the determination in step “S61” results in “NO”, which means that the pipeline is not being booted. The routine is advanced to step “S64”.

At step “S64”, to determine whether the pipeline processing is being interrupted, the start-up stage-determining unit 22 determines whether OFFSET3 is equal or greater than zero, as follows:

OFFSET3 >=0?

OFFSET3 is currently equal to zero (OFFSET3=0), and the determination in step “S64” results in “YES”, which means that the pipeline processing is being interrupted. The routine is advanced to step “S65”.
At step “S65”, the start-up stage-determining unit 22 calculates the pipeline stage start-up parameter (PIPEKICK), as follows:

PIPEKICK=TABLE2 [OFFSET2] [OFFSET3],

thereby obtaining the following parameter from the pipeline interruption table 420:

PIPEKICK=_S3,

then, the routine is advanced to step “S66”.

At step “S66”, to decrement the pipeline interruption table-adapted OFFSET3, the start-up stage-determining unit 22 makes calculation as follows:

OFFSET3−−,

thereby setting OFFSET3, as follows:

OFFSET3=−1.

Now, the pipeline start-up stage-determining process is terminated. At this time, parameters as discussed below are returned to the pipeline control unit 21 from the start-up stage-determining unit 22.

OFFSET1=32767;

OFFSET2=1;

OFFSET3=−1; and

PIPEKICK=_S3.

The routine is advanced to step “S22” of FIG. 5 to start up the pipeline processing. The pipeline processing in step “S22” is started up based on the pipeline stage start-up parameter “PIPEKICK=_S3” as determined in step “S21”. Accordingly, the third stage (S3) inverse DCT processing “P13” is activated.

At the next step “S23”, the pipeline control unit 21 waits for the end of the inverse DCT processing “P13”.

At step “S24”, to determine whether the pipeline processing is being interrupted, the pipeline control unit 21 determines whether OFFSET3 is unequal to −32768, as follows:

OFFSET3!=−32768?

OFFSET3 is currently equal to minus one (OFFSET3=−1), and the determination in step “S24” results in “YES”, which means that the pipeline processing is being interrupted. The routine is advanced to step “S31”. At step “S31”, to determine whether the interruption in the pipeline processing has been terminated, the pipeline control unit 21 determines whether OFFSET3 is equal to minus one, as follows:

OFFSET3==−1?

OFFSET3 is currently equal to minus one (OFFSET3=−1), and the determination in step “S31” results in “YES”, which means that the interruption in the pipeline processing has been terminated. The routine is returned to step “S13” of FIG. 4.

At step “S13”, to determine whether all of the in-frame macro blocks have completely been processed, the pipeline control unit 21 determines whether MBA is equal or greater then MB_IN_VOP, as follows:

MBA>=MB_IN_VOP?

At present, MBA and MB_IN_VOP are defined as follows:

MBA=48; and

MB_IN_VOP=48.

The determination in step “S13” results in “YES”, which means that all of the in-frame macro blocks have completely been processed. The decoding processing is now terminated.

Pursuant to the present embodiment, the variable length decoding processing unit 11, inverse quantization processing unit 12, and inverse DCT processing unit 13 are provided as processing units in the image-decoding processing. Alternatively, any other processing unit may be provided. As a further alternative, several processing units may be integrated into a single processing unit. These alternatives offer advantages similar to those of the present embodiment, even with a change in number of the pipeline processing stages.

### Second Embodiment

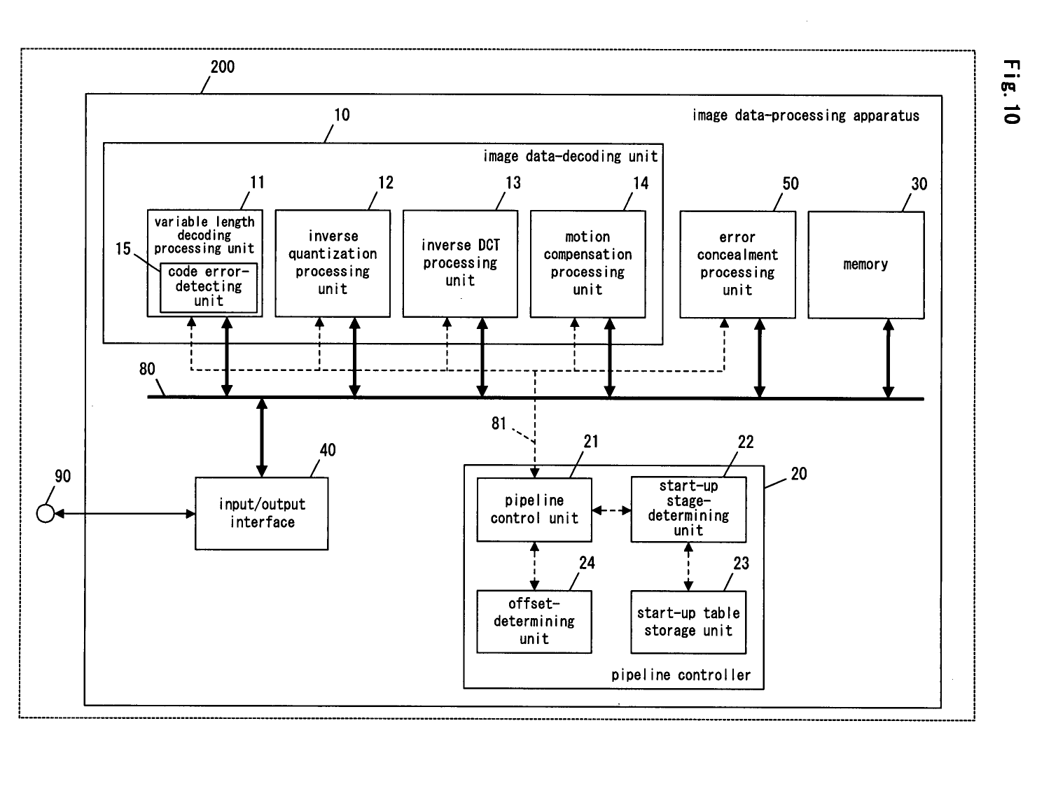

FIG. 10 is a block diagram illustrating an image data-processing apparatus 200 according to a second embodiment. Similar to the image data-processing apparatus 100 according to the previous embodiment, the image data-processing apparatus 200 according to the present embodiment provides the pipeline processing-aided, high-speed decoding of encoded data that conform to any moving image processing standard represented by the MPEG standard. In addition, the image data-processing apparatus 200 according to the present embodiment provides the efficient concealment of disturbances in decoded image display, which otherwise would be conspicuous in the presence of code errors in input encoded data.

In FIG. 10, the same reference characters are given to elements similar to those of FIG. 1, and descriptions related thereto are herein omitted.

The image data-processing apparatus 200 of FIG. 10 according to the present embodiment includes an image data-decoding unit 10, a pipeline controller 20, a memory 30, an input/output interface 40, and an error concealment processing unit 50.

The image data-decoding unit 10 includes a variable length decoding processing unit 11, an inverse quantization processing unit 12, an inverse DCT processing unit 13, and a motion compensation processing unit 14. The variable length decoding processing unit 11 includes a code error-detecting unit 15.

The pipeline controller 20 includes a pipeline control unit 21, a start-up stage-determining unit 22, a start-up table storage unit 23, and an offset-determining unit 24.

The error concealment processing unit 50, connected to a data bus 80, is connected to the pipeline controller 20 through a control line 81.

The other elements are similar to those of the image data-processing apparatus 100 according to the previous embodiment, and descriptions related thereto are herein omitted.

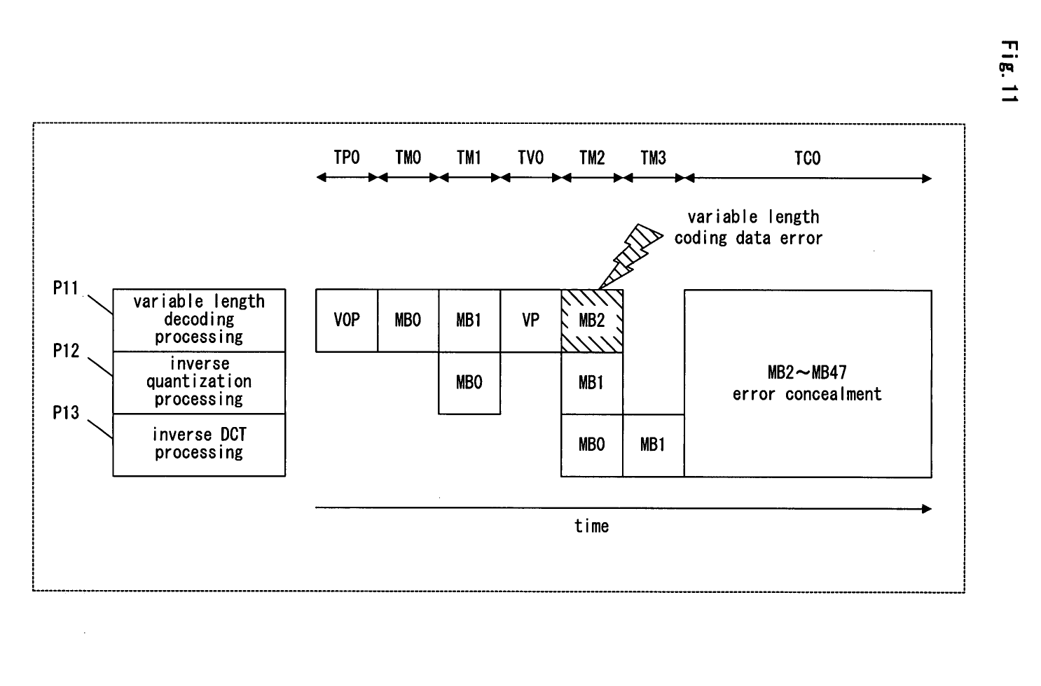

FIG. 11 is a time chart illustrating pipeline processing according to the present embodiment.

As illustrated in FIG. 11, the pipeline processing according to the present embodiment includes variable length decoding processing “P11”, inverse quantization processing “P12”, and inverse DCT processing “P13”. The horizontal and vertical axes of FIG. 11 denote time elapse and image decoding-related pipeline processing stages, respectively. The pipeline processing stages include three stages: the first stage (S1) of the variable length decoding processing “P11”; the second stage (S2) of the inverse quantization processing “P12”; and the third stage (S3) of the inverse DCT processing “P13”.

Further details of the processing “P11”, “P12, and “P13” are herein omitted because they are out of scope of the present invention.

Referring to the pipeline processing time chart of FIG. 11, error concealment processing is shown executed in response to the occurrence of decoding errors in the course of a macro block “MB2” being subjected to the variable length decoding processing “P11” during period “TM2”.

Periods “TP0” to “TV0” are similar to those of the pipeline processing time chart of FIG. 3 according to the previous embodiment, and detailed descriptions related thereto are herein omitted.

At the period “TM2” following the end of the variable length decoding processing “P11” of packet header information (VP) during the period “TV0”, macro blocks “MB2”, “MB1”, and “MB0” are subjected in parallel to the variable length decoding processing “P11”, inverse quantization processing “P12”, and inverse DCT processing “P13”, respectively.

The present embodiment assumes that the code error-detecting unit 15 detects errors in variable length code data from the macro block “MB2” in the process of the macro block “MB2” being subjected to the variable length decoding processing “P11”, thereby making it impossible to normally decode the present macro block “MB2” and subsequent macro blocks up to “MB47”. The error concealment processing is thereafter executed to suppress data error-caused disturbances in decoded images. Prior to the error concealment processing, the pipeline controller 20 allows all of the macro blocks “MB0” to MB2” under the pipeline processing to completely experience the three-staged processing up to the third stage inverse DCT processing “P13”. However, the macro block “MB2” need not be subjected to both of the second stage inverse quantization processing “P12” and the third stage inverse DCT processing “P13” because the data errors occurring at the macro block “MB2” in the course of the macro block “MB2” being subjected to the first stage variable length decoding processing “P11” preclude the macro block “MB2” from experiencing the further processing at the subsequent stages.

Accordingly, at the period “TM2”, the pipeline controller 20 terminates the parallel process of the variable length decoding processing “P11” applied to the macro block “MB2” (but, the processing “P11” is terminated after the detection of the errors and accompanying settlement thereof), the inverse quantization processing “P12” applied to the macro block “MB1”, and the inverse DCT processing “P13” applied to the macro block “MB0”.

At period “TM3”, the macro block “MB1” only experiences the inverse DCT processing “P13”.

At period “TC0” after the end of the processing during the period “TM3”, the macro blocks “MB2” to “MB47” are subjected to the error concealment process.

According to one of methods for the error concealment process, the errors are concealed by replacing the macro block in error and the subsequent macro blocks by the corresponding decoded images of a previous frame, e.g., an immediately previous frame, stored in the memory 30. In the image data-processing apparatus 200 according to the present embodiment, the macro blocks “MB2” to MB47”, which are cannot normally be decoded, may be replaced by corresponding macro blocks of decoded images of the immediate previous frame at the same positions. As a result, a complete frame of the decoded images is provided.

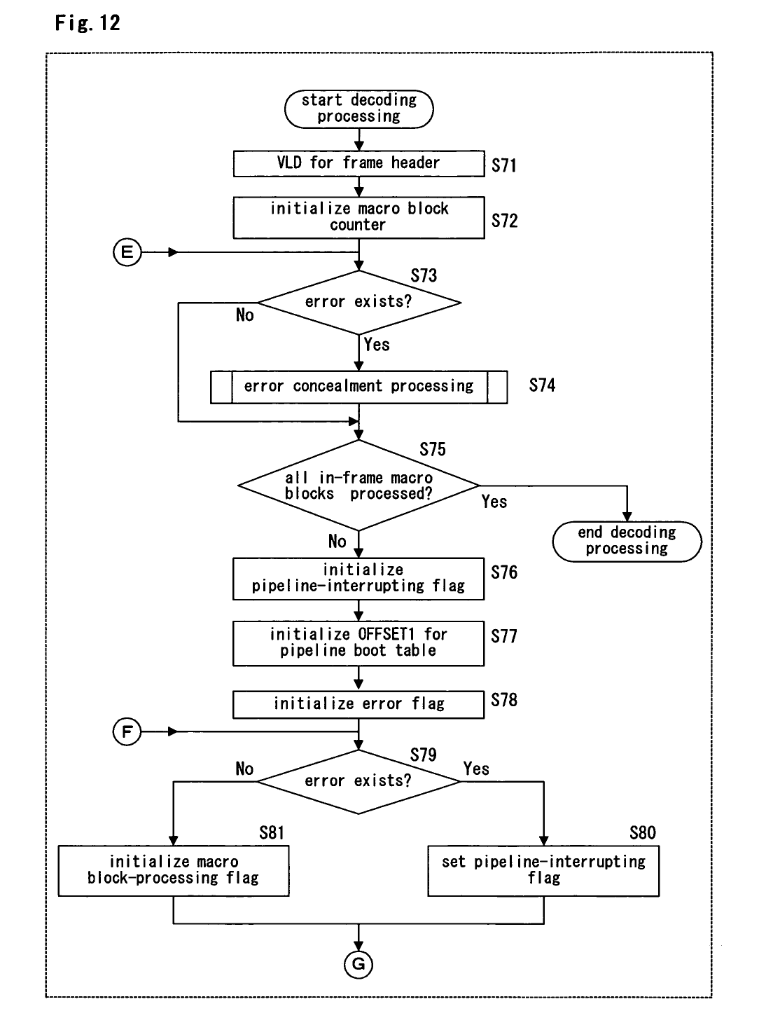

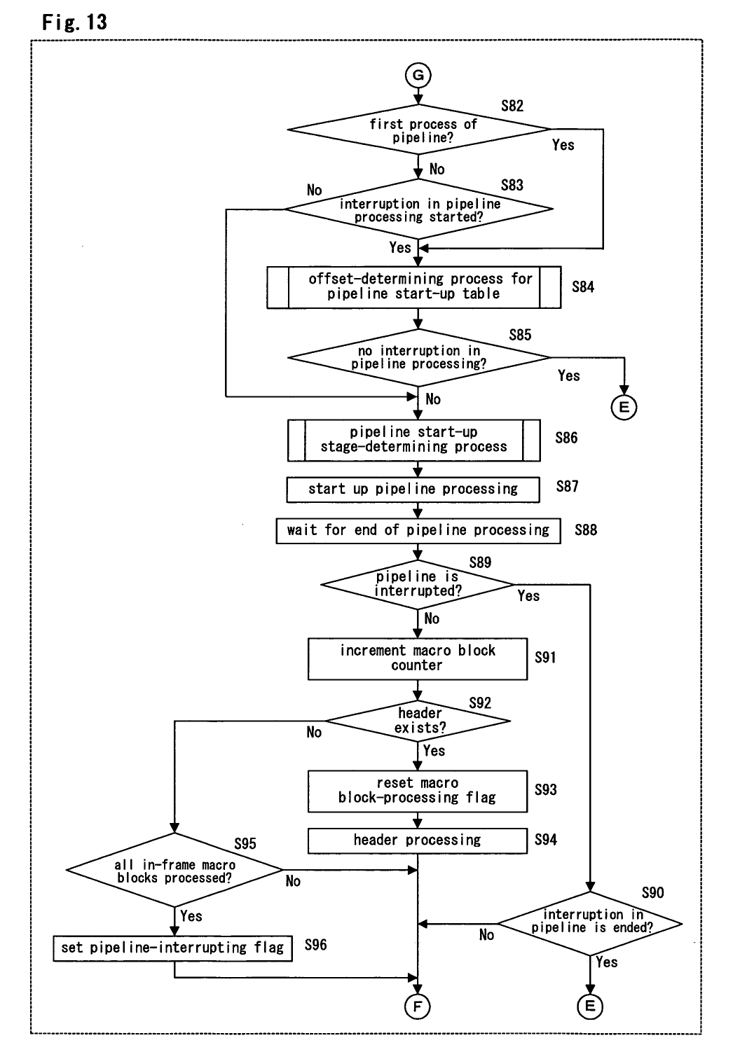

In light of the possible occurrence of the decoding errors of FIG. 11 in the image data-processing apparatus 200 of FIG. 10 according to the present embodiment, the following discusses a pipeline control method with reference to FIGS. 6 to 9 according to the previous embodiment and FIGS. 12 and 13 according to the present embodiment.

FIG. 12 is a flowchart illustrating the anterior half of pipeline control according to the present embodiment, while FIG. 13 is a flowchart illustrating the posterior half thereof. In FIG. 12, circled notations “E”, “F”, and “G” are linked to those of FIG. 13, respectively.

### Periods “TP0”, “TM0” to “TM1”, and “TV0”

The present embodiment assumes that no decoding errors occur during the present periods, and in error flag-initiating process at step “S78” of FIG. 12, an error flag (ERR) is set as being equal to zero, as follows:

ERR=0.

Accordingly, at steps “S73” and “S79” of FIG. 12 where the presence of the errors is determined, each determination results in “NO”. As a result, a flow of pipeline control executed in practice during the present periods is similar to that during periods “TP0”, “TM0” to “TM1”, and “TV0” according to the previous embodiment, and therefore descriptions related thereto are herein omitted.

### Period “TM2”

According to the aforesaid assumption, at the present period, the occurrence of the decoding errors under the pipeline processing is detected. The processing during the present period starts with step “S79” of FIG. 12.

At the beginning of the present period, major parameters are set as given below.

MBA=2;

PIPE_END=0;

MB_PROC=0;

OFFSET1=2;

OFFSET2=0;

OFFSET3=−32768; and

ERR=0.

At step “S79”, to determine whether errors are present, the pipeline control unit 21 determines whether ERR is unequal to zero, as follows:

ERR!=0?

The error flag (ERR) for use in determining the presence of errors is set by the code error-detecting unit 15 as being equal to one (ERR=1) when data errors are detected from variable length code data during the variable length decoding processing “P11”.

The error flag (ERR) is currently equal to zero (ERR=0), and the determination in step “S79” results in “NO”, which means that the errors are absent. The routine is advanced to step “S81”.

At step “S81”, the pipeline control unit 21 initializes the macro block-processing flag (MB_PROC), as follows:

MB_PROC=1.

The routine is advanced to step “S82” of FIG. 13.

At step “S82” of FIG. 13, to determine whether the pipeline processing is the first process of the pipeline, the pipeline control unit 21 determines whether OFFSET1 is equal to zero, as follows:

OFFSET1==0?

OFFSET1 is currently equal to two (OFFSET1=2), and the determination in step “S82” results in “NO”, which means that the pipeline processing is not the first process of the pipeline. The routine is advanced to step “S83”.

At step “S83”, to determine whether an interruption in the pipeline processing is started, the pipeline control unit 21 determines whether PIPE_END is unequal to zero, as follows:

PIPE_END!=0?

Since PIPE_END is currently equal to zero (PIPE_END=0), the determination in step “S83” results in “NO”, which means that no interruption in the pipeline processing is started. The routine is advanced to step “S86”.

At step “S86”, pipeline start-up stage-determining process is started. At this time, parameters as discussed below are delivered from the pipeline control unit 21 of FIG. 10 to the start-up stage-determining unit 22 of FIG. 10.

OFFSET1=2;

OFFSET2=0; and

OFFSET3=−32768.

At step “S86, the pipeline start-up stage-determining process is started to execute the processing according to the flowcharts of FIGS. 6 and 7. The pipeline start-up stage-determining process according to the present embodiment is similar to that according to the previous embodiment, and descriptions related thereto are herein omitted.

At the end of the pipeline start-up stage-determining process in step “S86”, parameters as given below are returned to the pipeline control unit 21 from the start-up stage-determining unit 22.

OFFSET1=32767;

OFFSET2=0;

OFFSET3=−32768; and

PIPEKICK=_S1|_S2|_S3.

At step “S87, the pipeline control unit 21 starts up the pipeline processing. In the start-up of the pipeline processing in step “S87”, all of the pipeline processing stages, i.e., the first stage (S1) variable length decoding processing “P11”, the second stage (S2) inverse quantization processing “P12”, and the third stage (S3) inverse DCT processing “P13” are activated in parallel in accordance the element “_S1|_S2|_S3” set in the pipeline stage start-up parameter (PIPEKICK) as determined in step “S86”.

At step “S88”, the pipeline control unit 21 waits for the end of the parallel activated processing stages. At the present step, the occurrence of the data errors in the variable length code data at the macro block “MB2” as assumed in the time chart of FIG. 11 is detected. More specifically, at the present step “S88”, the code error-detecting unit 15 detects the data errors from the variable length code data while the variable length decoding processing unit 11 of FIG. 10 subjects the variable length decoding processing “P11” to the macro block “MB2”, with the result that the error flag (ERR) is set as being equal to one, that is:

ERR=1.

The code error-detecting unit 15 detects the data errors from the variable length code data when, e.g., entered variable length code data does not exist in a variable length code table while the variable length decoding processing unit 11 is decoding the variable length code data with reference to the variable length code table. At the step “S89”, to determine whether the pipeline processing is being interrupted, the pipeline control unit 21 determines whether OFFSET3 is unequal to −32768, as follows:

OFFSET3!=−32768?

OFFSET3 is currently equal to −32768 (OFFSET3=−32768), and the determination in step “S89” results in “NO”, which means that the pipeline processing is not being interrupted. The routine is advanced to step “S91”.

At step “S91”, to increment a macro block counter (MBA), the pipeline control unit 21 makes calculation as follows:

MBA++,

thereby setting it as follows:

MBA=3.

The routine is advanced to step “S92.

At the next step “S92”, a determination is made as to whether the header is present. The determination in the present step is assumed to result in “NO”, which means that the header is absent. The routine is advanced to step “S95”. At step “S95”, to determine whether all of the in-frame macro blocks have completely been processed, the pipeline control unit 21 determines whether MBA is equal or greater than MB_IN_VOP, as follows:

MBA>=MB_IN_VOP?

At present, MBA and MB_IN_VOP are set as follows:

MBA=3; and

MB_IN_VOP=48.

Therefore, the determination in step “S95” results in “NO”, which means that there are still remaining macro blocks to be processed.

Now, the processing during the present period “TM2” is completed, and the routine is returned to step “S79” of FIG. 12.

### Period “TM3”

At the present period, the pipeline processing after the occurrence of the decoding errors is executed, and starts with step “S79” of FIG. 12.

At the beginning of the present period, major parameters are set as given below.

MBA=3;

PIPE_END=0;

MB_PROC=1;

OFFSET1=32767;

OFFSET2=0;

OFFSET3=−32768; and

ERR=1.

At step “S79”, to determine whether errors are present, the pipeline control unit 21 determines whether ERR is unequal to zero, as follows:

ERR!=0?

The error flag (ERR) is currently equal to one (ERR=1), and the determination in step “S79” results in “YES”, which means that the errors are present. The routine is advanced to step “S80”.

At step “S80”, to set the pipeline-interrupting flag (IPE_END), the pipeline control unit 21 sets it as follows:

PIPE_END=1.

The routine is advanced to step “S82” of FIG. 13.

At step “S82” of FIG. 13, to determine whether the pipeline processing is the first process of the pipeline, the pipeline control unit 21 determines whether OFFSET1 is equal to zero, as follows:

OFFSET1==0?

OFFSET1 is currently equal to 32767 (OFFSET1=32767), and the determination in step “S82” results in “NO”, which means that the pipeline processing is not the first process of the pipeline. The routine is advanced to step “S83”.

At step “S83”, to determine whether an interruption in the pipeline processing is started, the pipeline control unit 21 determines whether PIPE_END is unequal to zero, as follows:

PIPE_END!=0?

Since PIPE_END is currently equal to one (PIPE_END=1), the determination in step “S83” results in “YES”, which means that the interruption in the pipeline processing is started. The routine is advanced to step “S84”.

At step “S84”, parameters as discussed below are delivered from the pipeline control unit 21 of FIG. 10 to the offset-determining unit 24 of FIG. 10, thereby starting up pipeline start-up table referencing-adapted offset-determining process.

PIPE_END=1;

MB_PROC=1; and

OFFSET1=32767.

As a result, offset values (OFFSET1, OFFSET2, and OFFSET3) are determined, which are used to reference a pipeline start-up table stored in the start-up table storage unit 23 of FIG. 10. The stored pipeline start-up table includes a pipeline boot table and a pipeline interruption table.

As a result of the pipeline start-up table referencing-adapted offset-determining process, parameters as given below are returned to the pipeline control unit 21 from the offset-determining unit 24.

OFFSET1=32767;

OFFSET2=0;

OFFSET3=0; and

PIPE_END=0.

The routine is advanced to step “S85”.

At step “S85”, to determine whether the pipeline processing is to be uninterrupted, the pipeline control unit 21 determines whether OFFSET2 is equal to −32768, as follows:

OFFSET2=−32768?

OFFSET2 is currently equal to zero (OFFSET2=0), and the determination in step “S85” results in “NO”, which means that the pipeline processing is to be interrupted. The routine is advanced to step “S86”.

At step “S86”, the pipeline start-up stage-determining process is started. At this time, parameters as given below are delivered from the pipeline control unit 21 of FIG. 10 to the start-up stage-determining unit 22 of FIG. 10.

OFFSET1=32767;

OFFSET2=0; and

OFFSET3=0.

At the end of the pipeline start-up stage-determining process, parameters as given below are returned to the pipeline control unit 21 from the start-up stage-determining unit 22.

OFFSET1=32767;

OFFSET2=0;

OFFSET3=−1; and

PIPEKICK=_S3.

At the next step “S87, the pipeline control unit 21 starts up the pipeline processing. At the present step, the third stage (S3) inverse DCT processing “P13” is activated to act on the element “_S3” of the pipeline stage start-up parameter (PIPEKICK).

At step “S88”, the pipeline control unit 21 waits for the end of the inverse DCT processing “P13”.

At the step “S89”, to determine whether the pipeline processing is being interrupted, the pipeline control unit 21 determines whether OFFSET3 is unequal to −32768, as follows:

OFFSET3!=−32768?

OFFSET3 is currently equal to −1 (OFFSET3=−1), and the determination in step “S89” results in “YES”, which means that the pipeline processing is being interrupted. The routine is advanced to step “S90”.

At the step “S90”, to determine whether the interruption in the pipeline processing has been terminated, the pipeline control unit 21 determines whether OFFSET3 is equal to minus one, as follows:

OFFSET3==−1?

OFFSET3 is currently equal to minus one (OFFSET3=−1), and the determination in step “S90” results in “YES”, which means that the interruption in the pipeline processing has been terminated.

Now, the processing during the present period “TM3” is terminated. The routine is advanced to step “S73” of FIG. 12.

### Period “TC0”

At the present period, the error concealment processing is executed, and starts with step “S73” of FIG. 12.

At the beginning of the present period, major parameters are set as given below.

MBA=3;

PIPE_END=0;

MB_PROC=1;

OFFSET1=32767;

OFFSET2=0;

OFFSET3=−1; and

ERR=1.

At step “S73”, to determine whether errors are present, the pipeline control unit 21 determines whether ERR is unequal to zero, as follows:

ERR!=0?

The error flag (ERR) is currently equal to one (ERR=1), and the determination in step “S73” results in “YES”, which means that the errors are present. The routine is advanced to step “S74”.

At step “S74”, the error concealment processing is started to activate the error concealment processing unit 50 of FIG. 10. At this time, parameters as discussed below are delivered from the pipeline control unit 21 to the error concealment processing unit 50.

MBA=3; and

MB_IN_VOP=48.

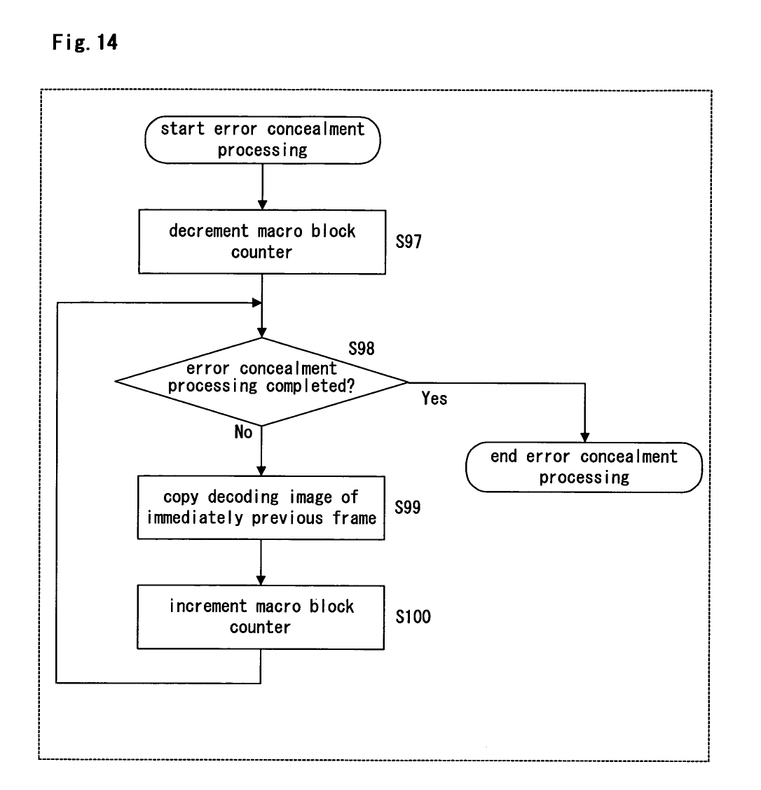

The following discusses the error concealment processing according to the present embodiment with reference to FIG. 14.

FIG. 14 is a flowchart illustrating the error concealment processing according to the present embodiment.

When the error concealment processing unit 50 of FIG. 10 is activated in response to the start of the error concealment processing in step “S74” of FIG. 12, then the error concealment processing is initiated in accordance with the error concealment processing flowchart of FIG. 14.

At step “S97” of FIG. 14, to match the macro block counter “MBA” with the macro block at which the decoding errors have occurred, the error concealment processing unit 50 makes calculation to decrement the macro block counter, as follows:

MBA−−,

The decrement results in “MBA=2” (“MBA=2” denotes the number of the macro block where the decoding errors have occurred.).

At step “S98”, to determine whether the error concealment processing has been completed, the error concealment processing unit 50 determines whether MBA is equal or greater than MB_IN_VOP, as follows:

MBA>=MB_IN_VOP?

MBA is currently equal to two (MBA=2), and the determination in step “S98” results in “NO”, which means that the error concealment processing is still in progress. The routine is advanced to step “S99”.

At step “S99”, to conceal the errors, a decoded image among decoded images of an immediately previous frame stored in the memory 30 of FIG. 10, in which such a corresponding decoded image is located at a position corresponding to that of the macro block “MB2”, is reproduced by the error concealment processing unit 50 onto the macro block “MB2” that is an object at which the errors in the corresponding decoded image of the present frame are to be concealed. The routine is advanced to step “S100”.

At step “S100”, to increment the macro block counter “MBA”, the error concealment processing unit 50 executes the following calculation:

MBA++,

thereby setting a new value to MBA, as follows:

MBA=3.

The routine is returned to step “S98”.

Subsequently, the processing from steps “S98” to “S100” is repeated until the macro block counter “MBA” reaches forty eight and sets as follows:

MBA=48.

At step “S98”, to determine whether the error concealment processing has been completed, the error concealment processing unit 50 determines whether MBA is equal or greater than MB_IN_VOP, as follows:

MBA>=MB_IN_VOP?

At present, MBA is equal to forty eight (MBA=48), and the determination in step “S98” results in “YES”, which means that the error concealment processing has been terminated. The error concealment processing is now terminated.

In this way, the error concealment processing that covers from the macro block “MB2”, at which the decoding errors have occurred, to the last macro block “MB47” is terminated. At this time, parameters as given below are returned to the pipeline control unit 21 from the error concealment processing unit 50.

MBA=48; and

MB_IN_VOP=48.

Subsequently, the routine is advanced to step “S75” of FIG. 12, at which, to determine whether all of the in-frame macro blocks have completely been processed, the pipeline control unit 21 determines whether MBA is equal or greater than MB_IN_VOP, as follows:

MBA>=MB_IN_VOP?

At present, MBA is equal to forty eight (MBA=48) and MB_IN_VOP is equal to forty eight (MB_IN_VOP=48), and the determination in step “S75” results in “YES”, which means that all of the in-frame macro blocks have completely been processed. Now, a series of decoding processes accompanied by the error concealment processing are terminated.

Pursuant to the present embodiment, the variable length decoding processing unit 11, inverse quantization processing unit 12, and inverse DCT processing unit 13 are provided as processing units for use in the image decoding processing. Alternatively, any other processing unit may be employed. As a further alternative, a plurality of processing units may be combined into a single processing unit. These alternatives provide similar advantages, even with a change in number of pipeline processing stages.

### Third Embodiment

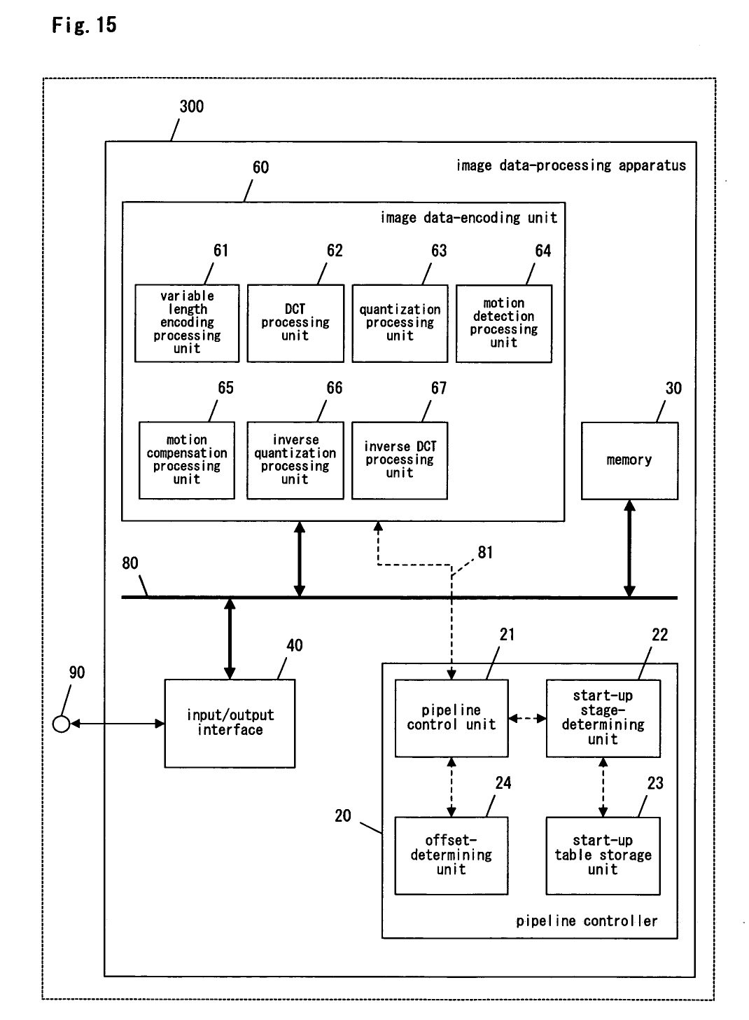

FIG. 15 is a block diagram illustrating an image data-processing apparatus 300 according to a third embodiment. The image data-processing apparatus 300 according to the present embodiment provides the pipeline processing-assisted, high-speed encoding of image data, for each macro block, into encoded data that conform to any moving image processing standard represented by the MPEG standard.

In FIG. 15, elements similar to those of FIG. 1 are identified by the same reference characters, and descriptions related thereto are herein omitted.

The image data-processing apparatus 300 of FIG. 15 according to the present embodiment includes an image data-encoding unit 60, a pipeline controller 20, a memory 30, and an input/output interface 40.

The image data-encoding unit 60 includes a variable length encoding processing unit 61, a DCT processing unit 62, a quantization processing unit 63, a motion detection processing unit 64, a motion compensation processing unit 65, an inverse quantization processing unit 66, and an inverse DCT processing unit 67.

The pipeline controller 20 includes a pipeline control unit 21, a start-up stage-determining unit 22, a start-up table storage unit 23, and an offset-determining unit 24.

The elements 61 to 67 of the image data-encoding unit 60, memory 30, and input/output interface 40 are connected to a data bus 80. The elements 61 to 67 are connected to the pipeline control unit 21 through a control line 81.

The motion detection processing unit 64 is operable to detect motion vectors of the present frame on the basis of input image data (i.e., input image data of the present frame) and reconfigured image data of a previous frame. The reconfigured image data of the previous frame is stored in the memory 30.

The motion compensation processing unit 65 is operable to generate predicted image data of the present frame on the basis of the detected motion vectors from the motion detection processing unit 64 and the reconfigured image data of the previous frame from the memory 30.

The DCT processing unit 62 is operable to perform the DCT processing of a difference between the predicted image data from the motion compensation processing unit 65 and the input image data, thereby providing DCT coefficients.

The quantization processing unit 63 is operable to quantize the DCT coefficients from the DCT processing unit 62, thereby providing quantized DCT coefficients.

The inverse quantization processing unit 66 is operable to inversely quantize the quantized DCT coefficients from the quantization processing unit 63, thereby providing inversely quantized DCT coefficients.

The inverse DCT processing unit 67 is operable to practice the inverse DCT processing of the inversely quantized DCT coefficients from the inverse quantization processing unit 66, thereby providing DCT coefficients for use in obtaining reconfigured image data.

The variable length encoding processing unit 61 is operable to perform the variable length encoding of the quantized DCT coefficients from the quantization processing unit 63 and the detected motion vectors from the motion detection processing unit 64, thereby providing encoded data.

The elements 61 to 67 as discussed above fall out of range of the present invention, and detailed descriptions related thereto are herein omitted.

In the image data-processing apparatus 300 according to the present embodiment, the pipeline controller 20 executes pipeline control over pipeline processing-assisted image encoding process in the image data-encoding unit 60.

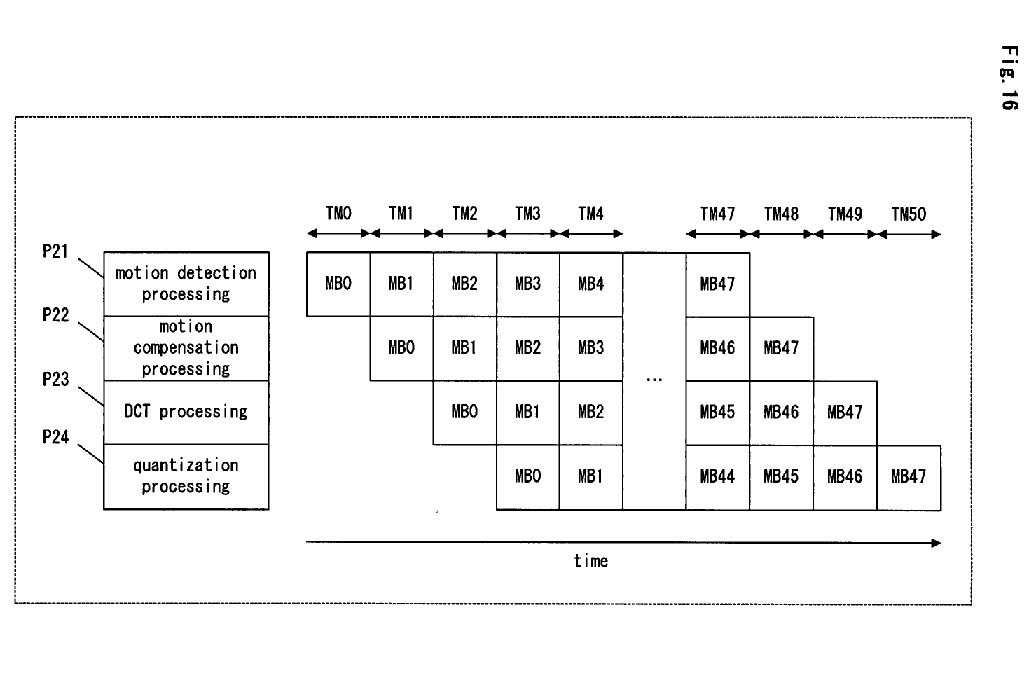

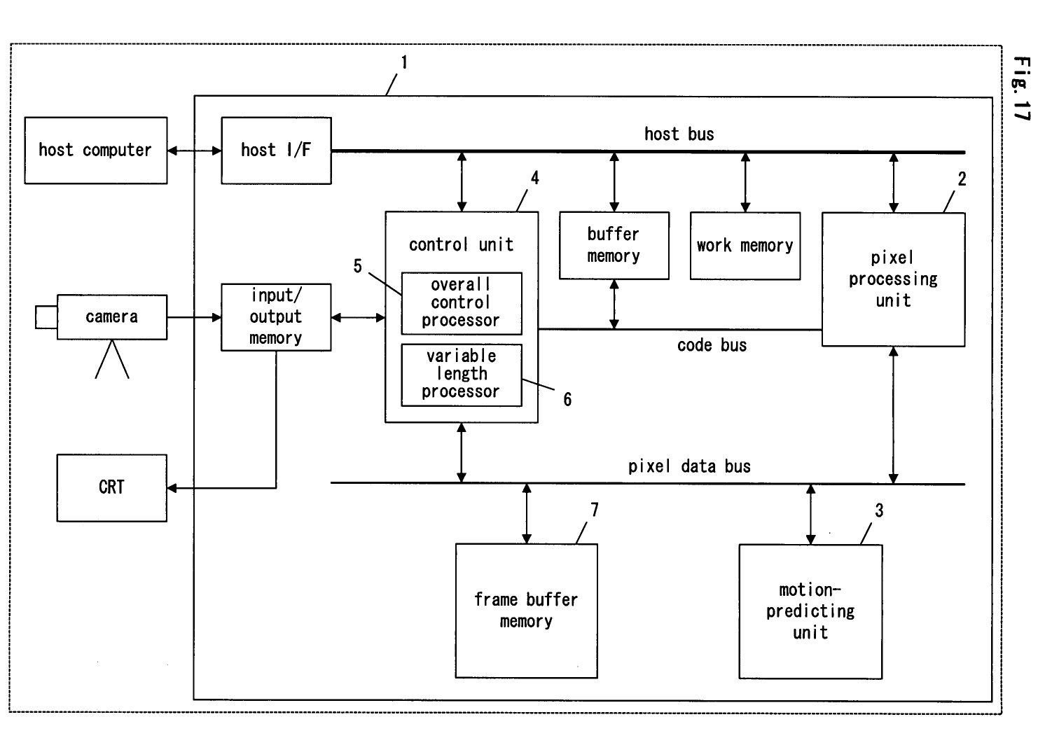

FIG. 16 is a time chart illustrating the pipeline processing according to the present embodiment. FIG. 16 illustrates an example of the pipeline processing-assisted, parallel process of motion detection processing “P21”, motion compensation processing “P22”, DCT processing “P23”, and quantization processing “P24” among a series of processes conducted by the image data-encoding unit 60. The following outlines the above parallel process.

At period “TM0”, a macro block “MB0” experiences the motion detection processing “P21”.

At period “TM1”, a macro block “MB1” and the macro block “MB0” are subjected in parallel to the motion detection processing “P21” and motion compensation processing “P22”, respectively.

At period “TM2”, a macro block “MB2”, the macro block “MB1”, and the macro block “MB0” are subjected in parallel to the motion detection processing “P21”, motion compensation processing “P22”, and DCT processing “P23”, respectively.

At period “TM3”, a macro block “MB3”, the macro block “MB2”, the macro block “MB1”, and the macro block “MB0” are subjected in parallel to the motion detection processing “P21”, motion compensation processing “P22”, DCT processing “P23”, and quantization processing “P24”, respectively.

At the following periods up to period “TM47”, the macro blocks “MB1” to “MB47” are repeatedly subjected to similar parallel process.

At period “TM48”, the macro blocks “MB47”, “MB46”, and “MB45” are subjected in parallel to the motion compensation processing “P22”, DCT processing “P23”, and quantization processing “P24”, respectively.

At period “TM49”, the macro blocks “MB47” and “MB46” are subjected in parallel to the DCT processing “P23” and quantization processing “P24”, respectively.

At period “TM50”, the macro block “MB47” experiences the quantization processing “P24”.

The above pipeline processing is controlled by the pipeline controller 20 of FIG. 15.

The start-up table storage unit 23 is provided with a pipeline start-up table for use in starting up the parallel process “P21” to “P24” as discussed above. The pipeline start-up table includes a pipeline boot table and a pipeline interruption table. The tables are configured in a manner similar to those of FIGS. 9(a) and 9(b), and detailed descriptions related thereto are herein omitted.

The offset-determining unit 24 is operable to determine offset values for use in referencing the pipeline boot table and the pipeline interruption table in the start-up table storage unit 23.

The start-up stage-determining unit 22 is operable to determine a pipeline stage-starting up method on the basis of the determined offset values from the offset-determining unit 24.

The pipeline control unit 21 is operable to activate corresponding pipeline stage elements of the image data-encoding unit 60 on the basis of the determined pipeline stage-starting up method from the start-up stage-determining unit 22.

The pipeline control flowchart according to the present embodiment can easily be analogized based on the pipeline control flowchart according to the first embodiment, and specific descriptions related thereto are herein omitted.

The above discusses the parallel process of the pipeline stages, i.e., the motion detection processing “P21”, motion compensation processing “P22”, DCT processing “P23”, and quantization processing “P24” in the image data-processing apparatus 300 according to the present embodiment. Alternative parallel process of other pipeline stages is acceptable as well. For example, if it takes a substantial period of time to transfer data between the motion detection processing unit 64 and the memory 30, the parallel process of the data transfer is achievable.

The present invention provides an image data-processing apparatus and method whereby the rapid and efficient encoding and decoding of image data is available in accordance with the pipeline processing.

As discussed above, an object of the present invention is to provide an image data-processing apparatus operable to provide the pipeline processing-assisted, high-speed and efficient encoding and decoding of image data. Therefore, the present invention finds various applications without departing from the spirit and scope of the present invention.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

### INDUSTRIAL APPLICABILITY

The image data-processing apparatus according to the present invention is applicable to image processing-requiring electronic apparatuses such as built-in camera-equipped cellular phones, and to fields of application thereof.

1. An image data-processing apparatus comprising:
an image data-decoding unit operable to allow input encoded data fed into said image data-processing apparatus to be decoded through pipeline processing, thereby providing decoded image data;
a pipeline controller operable to control the pipeline processing in said image data-decoding unit; and
a memory operable to store the input encoded data and the decoded image data.

2. An image data-processing apparatus as defined in claim 1, wherein said image data-decoding unit includes a several staged data-processing unit operable to practice the pipeline processing, and
wherein said several staged data-processing unit includes at least two of:
a variable length decoding processing unit operable to practice variable length decoding of the input encoded data, thereby providing quantized DCT coefficients and a motion vector;
an inverse quantization processing unit operable to inversely quantize the quantized DCT coefficients from said variable length decoding processing unit, thereby providing inversely quantized DCT coefficients;
an inverse DCT processing unit operable to practice inverse DCT processing of the inversely quantized DCT coefficients from said inverse quantization processing unit, thereby providing DCT coefficients; and
a motion compensation processing unit operable to generate decoded image data of a present frame using the DCT coefficients from said inverse DCT processing unit, the motion vector from said variable length decoding processing unit, and decoded image data of a previous frame stored in said memory.

3. An image data-processing apparatus as defined in claim 1, wherein said pipeline controller includes:
a start-up table storage unit operable to contain a pipeline start-up table in which start-up information on control over the pipeline processing in said image data-decoding unit is registered;
an offset-determining unit operable to determine an offset value for use in referencing the pipeline start-up table in said start-up table storage unit;
a start-up stage-determining unit operable to read the start-up information from the pipeline start-up table in said start-up table storage unit in accordance with the offset value determined by said offset-determining unit, thereby determining a start-up method for the pipeline processing in said image data-decoding unit; and
a pipeline control unit operable to control said offset-determining unit and said start-up stage-determining unit, thereby controlling the pipeline processing in said image data-decoding unit in accordance with the start-up method for the pipeline processing as determined by said start-up stage-determining unit.

4. An image data-processing apparatus as defined in claim 2, further comprising: an error concealment processing unit,
wherein said variable length decoding processing unit further includes a code error-detecting unit operable to detect a code error from the input encoded data, and
wherein, when said code error-detecting unit detects the code error at a macro block of the input encoded data, then said error concealment processing unit applies previously decoded image data from said memory onto the macro block at which the error has been detected, and onto subsequent macro blocks, thereby concealing a disturbance in decoded image display, the disturbance being caused by the code error in the input encoded data.

5. An image data-processing apparatus as defined in claim 4, wherein when said code error-detecting unit detects a code error at a macro block of the input encoded data, then said error concealment processing unit excludes previously processed macro blocks from targets at which the disturbance in decoded image display is to be concealed, the previously processed macro blocks being processed earlier, by the number of stages of the pipeline processing, than the macro block at which the error has been detected.

6. An image data-processing apparatus comprising:
an image data-encoding unit operable to allow input image data fed into said image data-processing apparatus to be encoded through pipeline processing, thereby providing encoded data;
a pipeline controller operable to control the pipeline processing in said image data-encoding unit; and
a memory operable to store reconfigured image data corresponding to the input image data, and the encoded data.

7. An image data-processing apparatus as defined in claim 6, wherein said image data-encoding unit includes a several staged data-processing unit operable to execute the pipeline processing, and
wherein said several staged data-processing unit includes at least two of:
a motion detection processing unit operable to detect a motion vector of a present frame, using the input image data, which is input image data of the present frame, and reconfigured image data of a previous frame stored in said memory;
a motion compensation processing unit operable to generate predicted image data of the present frame, using the motion vector detected by said motion detection processing unit, and the reconfigured image data of the previous frame in said memory;
a DCT processing unit operable to practice DCT processing of a difference between the predicted image data generated by said motion compensation processing unit, and the input image data, thereby providing DCT coefficients;
a quantization processing unit operable to quantize the DCT coefficients from said DCT processing unit, thereby providing quantized DCT coefficients;
an inverse quantization processing unit operable to inversely quantize the quantized DCT coefficients from said quantization processing unit, thereby providing inversely quantized DCT coefficients;
an inverse DCT processing unit operable to practice inverse DCT processing of the inversely quantized DCT coefficients from said inverse quantization processing unit, thereby providing DCT coefficients for use in obtaining reconfigured image data; and
a variable length encoding processing unit operable to practice variable length encoding of the quantized DCT coefficients from said quantization processing unit and the motion vector detected by said motion detection processing unit, thereby providing encoded data.

8. An image data-processing apparatus as defined in claim 6, wherein said pipeline controller includes:
a start-up table storage unit operable to contain a pipeline start-up table in which start-up information on control over the pipeline processing in said image data-encoding unit is registered;
an offset-determining unit operable to determine an offset value for use in referencing the pipeline start-up table in said start-up table storage unit;
a start-up stage-determining unit operable to read the start-up information from the pipeline start-up table in said start-up table storage unit in accordance with the offset value determined by said offset-determining unit, thereby determining a start-up method for the pipeline processing in said image data-encoding unit; and
a pipeline control unit operable to control said offset-determining unit and said start-up stage-determining unit, thereby controlling the pipeline processing in said image data-encoding unit in accordance with the start-up method for the pipeline processing as determined by said start-up stage-determining unit.

9. An image data-processing method comprising:
processing image data through a several staged pipeline;
storing the processed image data; and
controlling the several staged pipeline.

10. An image data-processing method as defined in claim 9, wherein said controlling the several staged pipeline includes:
storing a pipeline start-up table in which start-up information on control over start-up of the several staged pipeline is registered;
determining an offset value for use in referencing the pipeline start-up table;
obtaining the start-up information from the pipeline start-up table based on the determined offset value, thereby determining a start-up method for the several staged pipeline; and
controlling the several staged pipeline in accordance with the determined start-up method for the several staged pipeline.

11. An image data-processing method as defined in claim 9, wherein said processing the image data through the several staged pipeline includes:
decoding encoded data for each macro block;
detecting a code error from the encoded data; and
practicing error concealment processing,
wherein when a code error is detected at a macro block during said detecting the code error, said controlling the several staged pipeline includes interrupting decoding processing for macro blocks subsequent to the macro block at which the code error has been detected, whereby the error concealment processing is practiced.

12. An image data-processing method as defined in claim 11, wherein said practicing the error concealment processing includes applying previously processed image data that is stored by said storing the processed image data, thereby practicing the error concealment processing.
